(19) United States
(12) Patent Application Publication
(10) Pub. No.: US 2004/0181453 A1
(43) Pub. Date: Sep. 16, 2004

(54) Configurable stored value platform

(76) Inventors: James Thomas Ray, San Francisco, CA (US); Randall M. Chesler, Dallas, TX (US); Ozzy Espaillat, Tiburon, CA (US); Taranjit Lamba, Fremont, CA (US)

Correspondence Address: GLENN PATENT GROUP, 3475 EDISON WAY, SUITE L, MENLO PARK, CA, 94025, US

(21) Appl. No.: 10/705,160

(22) Filed: Nov. 6, 2003

Related U.S. Application Data
(60) Provisional application No. 60/424,478, filed on Nov. 6, 2002.

(51) Int. Cl. G06F 17/60

(52) U.S. Cl. 705/16

(57) ABSTRACT

The platform supports a wide variety of merchants who are interested in a loyalty and/or value card products. The platform is an integrated set of software packages and tools that allows merchants to develop and offer loyalty award and payment products. The platform consists of a series of sub-systems that form the operating environment for the loyalty and payment products, collectively called common systems herein. These systems work together to customize and orchestrate product functionality. The platform processes real-time messages from devices, such as point-of-sale and CRIND/ICR/ICR (gas pump) devices, that are modified to work with the platform. The platform responds to the messages from the devices with a range of actions from approval of the pending purchase to addition of loyalty points into an account. In the case of the system-based service, messages are formatted according to defined standards so that they can be received by the platform. Other devices currently supported by the platform include Kiosk, IVR, API, and Web. New modules may be added to the platform that allow it to accept translations in any data format.

### CROSS-REFERENCE TO RELATED APPLICATION

This application claims priority and incorporates by reference the provisional application, “Configurable Stored Value Platform System,” Application No. 60/424,478 filed Nov. 6, 2002.

### BACKGROUND OF THE INVENTION

1. Technical Field

The invention relates to loyalty and stored value card programs. More particularly, the invention relates to a configurable stored value platform that enables users to offer a full range of loyalty and stored value programs to consumers.

2. Description of the Prior Art

Consumer affinity programs abound. There is a large choice for the consumer between such programs as frequent flyer, frequent buyer, and customer club accounts, as well as gift cards and prepaid (Visa® or Mastercard®) branded) purchase cards. While most merchants now offer some variant of these programs, relatively few merchants offer related payment products on their own. This is largely because implementing a loyalty or stored value card program would require the merchant to handle all of the services required, including data processing and data storage for verifying the authenticity of the card, replenishment, cancellation, sale and authorization (pre/post) for purchases.

It would be advantageous to provide an apparatus and method that embodied all of the functionality required for offering loyalty and stored value products, processing transactions, managing programs and servicing customers.

### SUMMARY OF THE INVENTION

The presently preferred embodiment of the invention comprises an apparatus and method in the form of a platform that provides all of the functionality required for offering loyalty and stored value products, for processing transactions, managing programs, and servicing customers. Thus, all merchants subscribing to a system-based service, for example, can offer these loyalty and stored value products to their customers.

The platform supports a wide variety of merchants who are interested in a loyalty and/or value card products. The platform is an integrated set of software packages and tools that allows merchants to develop and offer loyalty award and payment products. The platform consists of a series of sub-systems that form the operating environment for the loyalty and payment products, collectively called common systems herein. These systems work together to customize and orchestrate product functionality. The platform processes real-time messages from devices, such as point-of-sale and CRIND/ICR/ICR (gas pump) devices, that are modified to work with the platform. The platform responds to the messages from the devices with a range of actions from approval of the pending purchase to addition of loyalty points into an account. In the case of the system-based service, messages are formatted according to defined standards so that they can be received by the platform. Other devices currently supported by the platform include Kiosk, IVR, API, and Web. New modules may be added to the platform that allow it to accept translations in any data format.

### BRIEF DESCRIPTION OF THE DRAWINGS

FIG. 1 is a high level diagram of a configurable stored value platform according to the invention;

FIG. 2A is a full diagram showing the creation of aliases according to the invention;

FIG. 2B is a full diagram showing the use of aliases according to the invention;

FIG. 3 is a block schematic diagram showing operation of the universal translator according to the invention;

FIG. 4 is a block schematic diagram showing the pre-processor portion of the rules engine according to the invention;

FIG. 5 is a flow diagram showing promotion creation workflow according to the invention;

FIG. 6 is a flow diagram showing an object/package model for transactions according to the invention;

FIG. 7 is a flow diagram showing the creation of a card bundle according to the invention;

FIG. 8 is a flow diagram showing household links according the invention;

FIG. 9 is a block schematic diagram showing organization structure according to the invention;

FIG. 10 is a flow diagram showing phantom fees according to the invention;

FIG. 11 is a flow diagram showing community links according to the invention;

FIG. 12 is a flow diagram showing a closed coalition according to the invention;

FIG. 13 is a flow diagram showing an open system according to the invention and;

FIG. 14 is a flow diagram showing a card bundle according to the invention.

### DETAILED DESCRIPTION OF THE INVENTION

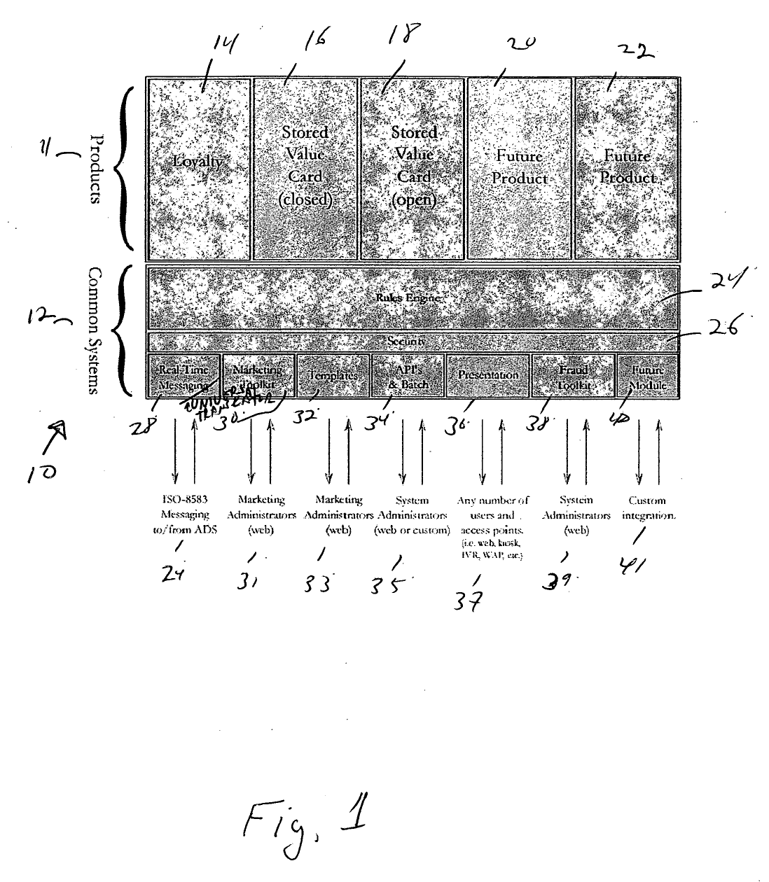

The presently preferred embodiment of the invention comprises an apparatus and method in the form of a platform (see FIG. 1) that provides all of the functionality required for offering loyalty and stored value products, for processing transactions, managing programs, and servicing customers. Thus, all merchants subscribing to a system-based service, for example, can offer these loyalty and stored value products to their customers.

The platform supports a wide variety of merchants who are interested in a loyalty and/or value card products. The platform is an integrated set of software packages and tools that allows merchants to develop and offer loyalty award and payment products. The platform consists of a series of sub-systems that form the operating environment for the loyalty and payment products, collectively called common systems herein. These systems work together to customize and orchestrate product functionality. The platform processes real-time messages from devices, such as point-of-sale and CRIND/ICR/ICR (gas pump) devices, that are modified to work with the platform. The platform responds to the messages from the devices with a range of actions from approval of the pending purchase to addition of loyalty points into an account. In the case of the system-based service, messages are formatted according to defined standards so that they can be received by the platform. Other devices currently supported by the platform include Kiosk, IVR, API, and Web. New modules may be added to the platform that allow it to accept translations in any data format.

The following glossary defines various terms that appear in the description of the invention set forth herein:

### Glossary of Terms

Application Programming Interface—A well-defined method, using standards-based technology that allows a host-to-host interaction without modifications to the platform

Behavior Template —A template that defines the actions the platform must perform once the conditions configured in the target template are satisfied.

Bucket—A set of cards belonging to the same network and generated/verified using the Luhn formula. The Luhn formula based on ANSI X4-13, confirms that the card numbers are valid. Each number may or may not have been assigned to a member in the form of a card.

Bundle Group—A set of bundles, which the client wishes to treat together for report summarization and rulemaking purposes.

Bundle—A group of card numbers assigned from a bucket at the same time. A bundle often corresponds to the actual printing of a box of cards.

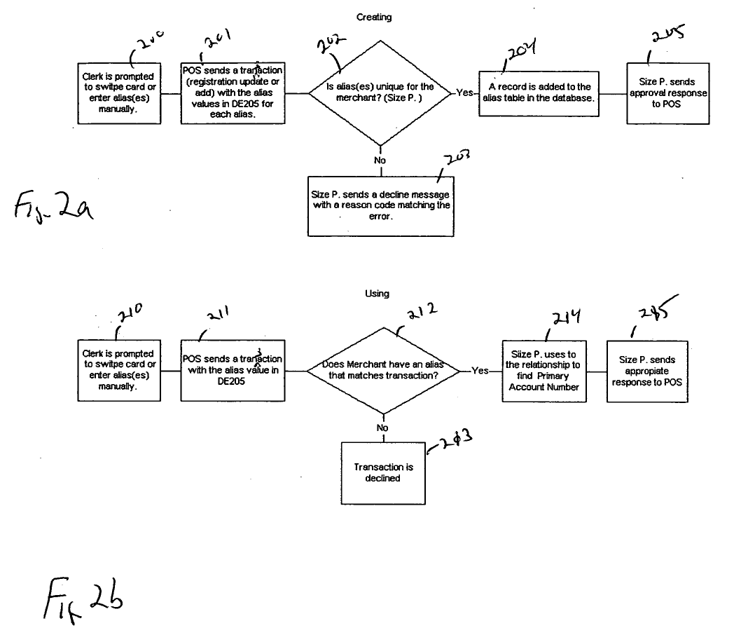

Card Alias—An identifier, such as driver's license, credit card, or phone number, which can be used in place of a card. The alias may contain both letters and digits. Within a single merchant/coalition, every alias must be unique. Briefly, an alias is created (see FIG. 2A), for example, when a clerk is prompted to swipe a card or enter an alias manually 200. The point-of-sale terminal sends a transaction with an alias value for each alias 201. Determination is made to see if the alias is unique to the merchant 202. If not, a decline message and the reason code are sent 203. Otherwise, a record is added to the alias table on a database 204 and an approval response is sent to the point-of-sale terminal 205. In use (see FIG. 2B), a clerk is prompted to swipe a card or enter an alias manually 210 and the point-of-sale terminal sends a transaction with the alias value 211. A determination is made as to whether the merchant has an alias that matches the transaction 212. If not, the transaction is declined 213. Otherwise, the relationship for the merchant is used to find a primary account number 214 and the appropriate response is sent to the point-of-sale terminal 215.

Client/Merchant—The issuer of a card.

Common Systems—Systems internal to the platform that are used to customize and support all the products within the platform.

CRIND/ICR/ICR—An unattended point of sale that is specifically used for the purchase of petroleum (Gas Pump).

Marketing Toolkit—A Web-based, suite of tools, templates, presets and reports that empower the MA to create and manage products and promotions/programs.

Member—The customer or cardholder.

Network—A payment network between transaction originators and processors, such as Visa, MasterCard, American Express, Plus, Star, Cirrus, etc.

Plug-in Module—A software module that can be connected to an existing system to enhance its functionality without any modification to the existing system.

Product—Any payment mechanism that can be customized and controlled by the rules engine. The invention herein concerns stored value open/closed system and loyalty.

Product Code—Any code including UPC, NACS, merchant-defined, or virtually any other standards based code that, in the preferred embodiment, is less than or equal to 16 characters or digits in length.

Product Type—A product's classification by the type of value accumulated, scope of information availability, and usage. The three products types referred to herein are open payment, private-label payment, and loyalty value payment cards.

Purse—An accounting of value, either non-currency or currency value (points, miles, and discounts), available for a particular card/account.

Purse type—The properties that serve as the definition of a purse.

Rules—Product definitions, programs, and/or promotions.

Rules Engine—The backend subsystem and framework that enable the creation, activation, and execution of rules.

Scope—A coalition, merchant, brand, division, region, or store as define by the merchant(s).

Target Template—The conditional components of a promotion or rule (see also Behavior Template).

Template—A Web-based software module which resides within the marketing toolkit, and that is used to define system, product, and promotional rules. Templates can be used individually or in combination with one another. There are two types of templates in the preferred embodiment, i.e. target and behavior.

Universal Translator—A subsystem used to communicate with many different kinds of external systems. The universal translator translates requests from external systems into a format that is common to all other subsystems within the platform. It also translates responses into a format that the external system understands. This subsystem is expandable. New plug-ins may be added to support other messaging formats.

### Discussion

The invention provides a comprehensive loyalty and value card system that offers a loyalty promotion/program, closed system stored value, and open system (Visa® or MasterCard® branded) stored value products. These products are compelling to consumers because they provide consumers with meaningful rewards and a convenient way to pay. The invention thus comprises a set of products that generate increased profits for merchants by enhancing loyalty and providing new ways to pay. The invention allows for these products to be issued individually, gift card only, or for the products to be combined to form a unique product, i.e. a gift card that also has features of the loyalty card.

The following represents key cardholder and merchant aspects of an exemplary promotion/program supported by the invention:

Administration

Before products can be offered, the platform operator must set the product parameters using the administration function. The merchant can configure the user access permission for various individual users, support groups such as customer service, and individual stores that access the platform.

The merchant can configure the card properties that become the hard product parameters of the particular group of cards.

The system-based service or the merchant can handle operational administration of the marketing promotions/programs at various scope levels, i.e. system, open coalition, merchant, brand, division, region, store.

Marketing

The platform operator uses this interface to set up and track various promotions.

The merchant can set the parameters for the stored value and loyalty promotions/program for immediate deployment.

The merchant can have manufacturers sponsor product specific loyalty promotions/programs, in those applications where the system can identify purchases down to the Product Code (UPC/NACS) level.

The merchant can add other merchants that are new to the system into the loyalty promotion/program, thereby creating their own coalition. Each merchant must be a member of a coalition, but a merchant may be the only member, if it so chooses.

Merchants can offer a combination of loyalty and closed or open system stored value, thus offering the benefits of loyalty and stored value in an integrated card, e.g. single swipe.

Merchants can select the reports to view and assign viewing rights to the various users.

Customer Service

Customer service management can allow functionality permissions to match their organizations capabilities.

Call center representatives use this interface to answer any customer questions regarding products.

Consumer

Cardholders get a loyalty account that can be identified by a card, allowing them to earn points based on purchase behavior or other items based on the merchant's objectives.

Cardholders can open accounts for the products in numerous ways:

Fill out a paper form with registration information and submit it directly to a merchant employee or mail it;

Provide information to a point-of-sale operator for instant registration;

Call the merchant's customer service department and provide the information over the phone;

Fill out a Web-based form at the merchant's Web site; and

Fill out a Web-based form at a kiosk.

### Loyalty and Stored Value Platform Overview

The inventive platform integrates stored value and loyalty reward programs with existing merchant point of sale and transaction processing systems; allows implementing a closed system stored value purchasing product that provides payment exclusivity for the issuing merchant; provides highly-flexible loyalty program capabilities and open system stored value products that can be made to work on existing open systems using existing Visa®, MasterCard®, PLUS, CIRRUS, STAR, and other networks

The platform also allows merchants to form coalitions, which enables sharing of promotions and programs. Options and benefits include:

The ability to define closed coalitions, which allow the issuing merchant to retain ownership of accounts, while offering another merchant's points and promotions programs, I.E. Blockbuster issuing American Airlines points to Blockbuster clients who could redeem their points at American;

Opportunities to participate in open coalitions, which allow consumers of participating merchants to enjoy promotions and programs shared by all merchants in the coalition, while the accounts are owned by a third party at the coalition level, I.E. a consumer's ability to use their Blockbuster loyalty card at Starbucks and receive awards point that can be redeemed at any merchant in the open coalition.

The platform provides tools for producing customized transaction processing which trigger associated promotions through a powerful yet flexible administrator interface that allows marketing personnel to assemble the building blocks for promotions easily.

Administration

Through the integrated system administration interface, users can configure a new client within 15 minutes, and can create and manage client organizational structures, system security, card manufacturing, back end logging, and configuration controls.

System security features include:

Creating, viewing, and modifying user groups, and individual user (associate) accounts with all levels of permissions;

Fine-tuning user group access, and allowing or blocking access to specific functions, and users within a specified group, which may also be restricted to these access scope levels through this interface.

The card management features offer administrators the complete suite of tools for defining all card parameters and generating the data needed for the manufacturing process.

The system administration interface also offers these tools:

Error logs

System logs (for transaction requests and responses)

Ability to define database failover

Data mirror configuration parameters

A separate client administration interface gives a system superuser easy access to the features used to create and maintain the security settings and card management data associated with a client's organization, all from one screen.

This tool includes:

All features related to creating and maintaining user groups, associate accounts, and associated permissions

All card management functions required to define card parameters and support card manufacturing

A secure Web-based cardholder account management interface allows customers to login and access these features:

Immediate snapshot view of account status

Marketing Tool Kit

The marketing toolkit provides the features to build all components required for a promotion:

Account balance data entities (“Purses”)

Messages

Coupons

Product Definitions

Product Groups

The toolkit assists an administrator in designing the promotion logic by providing promotion triggers, such as:

Business Code

Card Scope

Date Range

Organizational Scope

Product Quantity

and then linking them with and/or logic through a wizard-like interface. The promotion administrator may then associate an action (“behavior”) based on previously selected triggers.

Examples of behaviors include:

Cardholder Notification

Dispatch Coupon

Display Account Balance

Also within the marketing toolkit, administrators have access to extensive reporting facilities that provide extremely flexible data mining. Predefined reports provide extensive details about cardholders, promotions, and associated transactions.

Examples of predefined reports include:

Account Balance Summary

Enrolled Cardholders by Store

Registered Accounts

Transaction Details

Loyalty Promotions Summary

A marketing superuser toolkit provides administrative features for long-term maintenance of components used in promotions.

Marketing toolkit superuser features include:

Coupon archiving product definition archiving

Product group archiving promotion archiving

Viewing loyalty and stored value offerings

A marketing superuser may also create and maintain user groups and associated user accounts to control associates' access to the marketing toolkit.

Customer Service Interface

The customer support representative (CSR) interface allows support representatives to perform secure and confidential inquiries on accounts easily and quickly, and execute customer authorized real-time updates. Quick and easy capture of all cardholder profile data allows the CSR to register cardholders efficiently, which enables reliable communication with customers for handling account questions and notifying cardholders of current and upcoming promotions.

Cardholder profile details include:

Name

Address

SSN

Home, office, and cell phone

Email address, etc.

Other features for supporting cardholder accounts through the CSR interface include:

Creating and managing household links, which allow family members to share promotions, points, and other card benefits across multiple accounts;

Creating and managing community links, which allow cardholders to allocate a portion or all of their account awards (points or cash value) to the charity of their choice;

Viewing account balance history;

Viewing coupons associated with the account;

Generating account statements.

Extensive transaction user interface tools allow authorized representatives to execute transactions, e.g., adjustments, voids, etc., to assist sales clerks and cardholders and can fully emulate the POS terminal from a remote system. The complete set of loyalty and stored value transactions that can be sent from the POS are also available from this CSR interface.

Examples include:

Account activation

Loyalty participation

Loyalty redemption

Stored value sale

Reissue

Void

The CSR interface allows representatives to create, view, and modify trouble tickets and associated tasks. Representatives are also able to view a client's organizational structure from within this same interface. A CSR superuser toolkit allows an administrator to create and maintain user groups and associated user accounts to control representatives' access to the CSR interface.

Consumer

Cardholder Web site. Easy online account registration is provided to capture cardholder profile data, which enables reliable communication between merchants and customers, and facilitates notifying cardholders of current and upcoming promotions through various media. These profile data are the same as those accessed by customer support representatives and include, for example:

Name

Address

SSN

Home, office, and cell phone

Email address

Other features of the invention include:

Easily customizable generation of statements that provide detailed account history;

A Web-based messaging interface which allows the cardholder to send requests and inquiries to customer support;

The ability to replenish accounts from credit cards or checking accounts (ACH);

Links to catalog Web sites with special offers for cardholders, along with information regarding other available redemption options;

A store locator which allows the cardholder to search for participating merchants based on geographical criteria, e.g. Zip code;

The ability for cardholders to create and manage their own community links which allow the customer to allocate a portion or all of their account awards, e.g., points or cash value, to the charity of their choice.

Interfaces to the Platform. As users interact with point-of-sale and CRIND/ICR locations, the system-based service receives transaction messages from devices connected to its network and sends the transactions to the platform for processing.

FIG. 1 is a high level diagram of a configurable stored value platform 10 according to the invention. The platform sends requests for pre/post authorization and sale messages for the supported products.

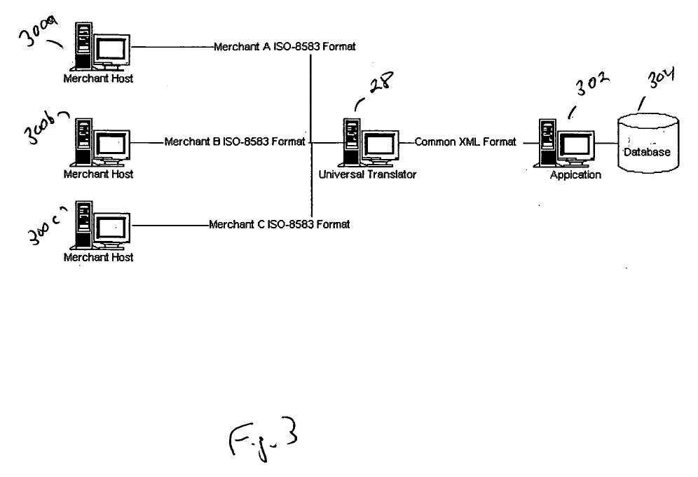

The interface that is responsible for translating the system-based service messaging protocol into a format that the platform understands is called the universal translator 28. The universal translator (FIG. 3) receives information from various hosts 300A-300C in various formats. The purpose of the universal translator 28 is to accept these messages and to translate them into a common XML format which is then forwarded to the system application 302 which operates in conjunction with the system database 304.

Once a message is received, the platform performs the data processing and storage required to provide loyalty reward and payment product processing. Upon completing these tasks, the platform generates a response message and sends it to the system-based service access engine. From there, the message is passed along to the device that initiated the transaction.

The modular architecture of the real-time messaging interface and the universal translator 28 allows for the development of plug-in software modules that are capable of translating incoming messages in virtually any data format to the standard XML format used by the platform. The modules support proprietary and open protocols, ensuring that the platform is positioned to grow with new and emerging commerce technologies. Furthermore, these new data formats can be added without making changes to the platform.

### The Platform

FIG. 1 shows the platform as comprising a products layer 11 and a common systems layer 12. The common systems support the various loyalty and stored value applications, such as loyalty programs 14, stored value cards for closed systems 16 and open systems 18, and various other products 20, 22. Both the products and the common systems are discussed in greater detail below.

System APIs and Batch Processes

System APIs 34 allow, for example, system administrators 35 for merchants and their partners to integrate the platform into their internal systems. These modifications do not require custom development by the system-based service. For example, a merchant can connect cardholder behavior on their own Web site to the issuance of points by the platform. XML interfaces allow for the real-time interaction between the platform and merchants' proprietary systems. By allowing for device inputs from outside systems and networks used by merchants and their vendors to issue points, register accounts, and perform other administrative tasks from a wide range of PC, Web-based and closed-system (such as point-of-sale terminals) input devices, the XML interfaces ensure the consistency of the data being sent to the system and the responses being sent from the system to the terminal or device that called them. Batch processes are supported as well. A file listing a series of transactions may be sent to the system from merchants or merchant vendors. An example of this is batch processing of registrations for loyalty cards.

Security Manager and Scope

The platform provides the following scope levels:

System

Open

Coalition

Merchant

Brand

Division

Regional

Store

Transaction messages 24 arriving at the real-time messaging interface 28 (see, also, the universal translator, discussed above) are sent to the security manager 26 to determine eligibility for further processing. Permissions are the combination of operation and scope. Groups are assigned a set of permissions, and each user must be and is only a member of one group. The security manager authenticates the transaction, verifies the message format and grants access to operations based on permissions that were established using the administrative interface. Users are only permitted to view reports and access system controls as designated by permissions and scope. Users with permissions at one scope may perform operations based on the permissions within or below their assigned scope. They may not perform operations above their assigned scope. For example, a marketing administrator (MA) with brand scope may create promotions for a specific store. However, the MA with brand scope is prevented from creating promotions at the merchant level. Furthermore, an MA with brand scope may not create promotions for stores not under his brand. The system-based service designates group(s) with system scope, and these groups should be limited to employees.

Marketing Toolkit

The marketing toolkit 30 is a Web-based suite of tools, templates, presets, and reports that empower the marketing administrator (MA) 31 to create and manage products and promotions/programs. Using the toolkit, the MA can:

Create, configure, and modify product;

Create, modify, and deactivate rules and presets; and

Customize Web site access reports.

Rules Engine

Rules are defined as product definitions, programs, and/or promotions. However, rules are software programs that are written by MA's using the marketing toolkit. The MA may define extremely simple to very complex rules using a Web-based interface. Loyalty reward promotions/programs and payment products are built on rules that govern the product. A promotion/program or rule consists of a set of conditions and actions. These conditions and actions are defined in a set of user interface components called templates. The rules engine 24 examines incoming transaction messages to see if they fall under the definition set forth in templates. When a match is found, the rules engine performs the actions specified in the rule set. The data required to qualify or execute the rule may be embedded in the transaction message or retrieved from another data source.

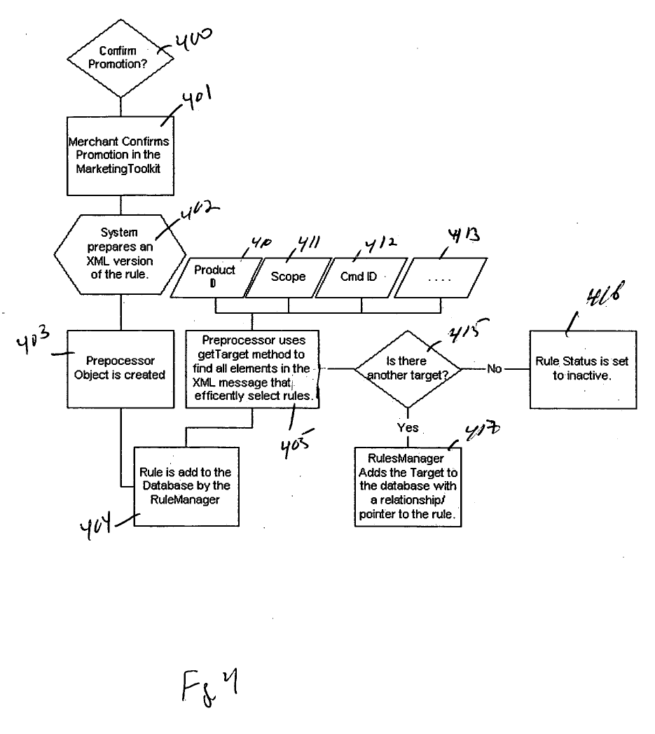

FIG. 4 is a flow diagram showing a pre-processor portion of the rules engine according to the invention. The pre-processor's role is to make targeting or finding rules that apply to the specific transaction quick and inexpensive in the use of processing time and the consumption of I/O resources. The pre-processor allows the system to support a very large universe of rules and promotions. The process begins when the pre-processor confirms the promotion 400. The merchant confirms the promotion in the marketing tool kit 401 and the system prepares an XML version of the rule 402. A pre-processor object is created 403 and the rule is added to the database by the rule manager 404. The pre-processor uses a get TARGET method to find all elements in the XML message that effectively select rules 410-413. The system then determines if there is another target 415. If not, the rule status is set to inactive 416. Otherwise, the rules manager adds the target to the database with the relationship/pointer to the rule 417.

For example, a simple loyalty reward promotion/program is:

For every unit of item ‘1343101018’ purchased by the cardholder, then add 100 points to the cardholder's loyalty reward account.

Templates

There are two kinds of templates 32, i.e. target and behavior.

Target templates are used to define the data that triggers a promotional operation. In the example above, the target template is the “Product Code Template.”

Behavior templates tell the system what action to take. Based on the target rules, the behavior template is, for example, “Add Value to Purse.”

This target templates tell the system when to take an action, and merchant administrators 33 place templates into a logical sequence to form rules/promotions.

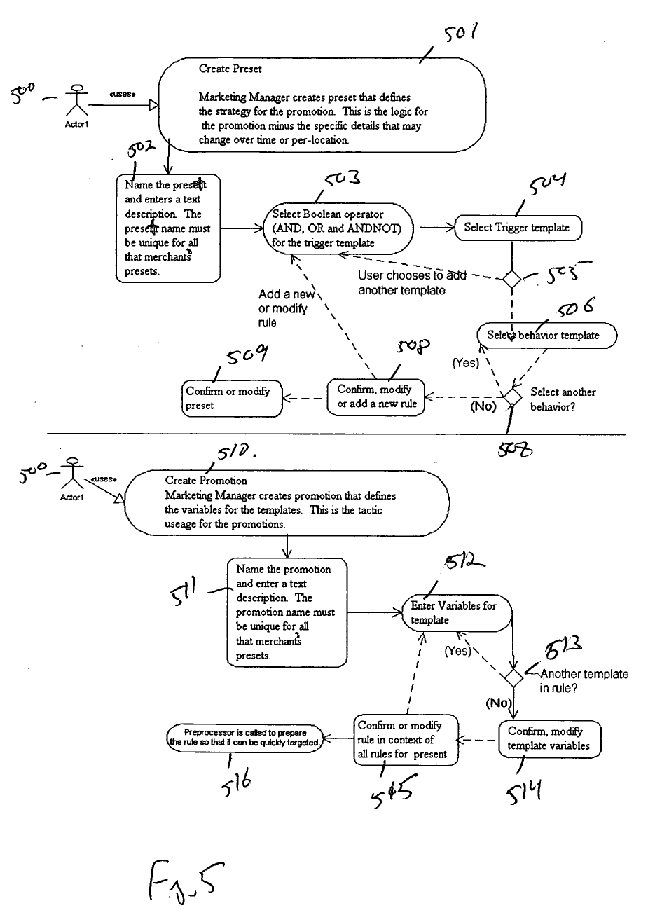

FIG. 5 is a flow diagram that shows a promotion creation workflow according to the invention. In the workflow an Actor1 uses the system to create a preset 501. In this case the marketing manager creates a preset that defines the strategy for a promotion. This is the logic for the promotion, minus the specific details that may change over time or per location. The preset is named and text is entered and a text description is entered 502. The preset name must be unique for all of the particular merchant's presets. A Boolean operator is then selected for a trigger template 503, such as AND, OR, or ANDNOT. A trigger template is selected and the user may choose to add another template 505 or may select a behavior template 506. Thereafter, the user may choose to select another behavior 507, or may proceed to confirm, modify, or add a new rule 508. Finally the preset may be confirmed or modified 509.

With regard to a promotion, the Actor1 500 uses the system to create a promotion 510. In this case the marketing manager creates a promotion that defines the variable for the templates. This is the tactic usage for the promotions. The promotion is named and a text description is entered 511. The promotion name must be unique for all of a particular merchant's presets. Variables are entered for the template 512 and a decision is made whether to add another template in the rule 513. If not, the user confirms or modifies the template variables 514 and confirms or modifies the rule in the context of all rules for the preset 515. Thereafter, the preprocessor's called to prepare the rule so that it can be quickly targeted 516.

All templates have customizable properties called constraints. In the above example, the constraint for the target template is “UPC code” with the value of ‘1343101018’ and the constraint for the behavior template is “Points Value” of 100 points.

A promotion/program might consist of multiple target templates connected to multiple behavior templates. For example, if the targeted PRODUCT CODE and targeted MERCHANT LOCATIONS/SCOPE are present in a transaction, then the system responds with the ISSUE POINTS behavior and the PRINT PRODUCT SPECIFIC MESSAGE ON RECEIPT behavior. With the constraint the rule would read “if the target product code of ‘123456’ and the target merchant scope of ‘Acme Merchant Western Region’ are present in a transaction, respond with the “ISSUE 100 POINTS” behavior and print “Enjoy your Acme Widget” message on receipt behavior.”

Scope can be defined at coalition, merchant, brand, division, region, or store levels. If no scope is defined in the rule, then the broadest definition, based on the MA's scope, applies to the rule. The definition of a rule/promotion without the constraints is referred to as a preset. Presets are useful in reapplying the same promotion/program with different constraints. Even if a rule does not need to be saved, creating a preset is a required step in defining a rule. Presets may be used as a basis for defining new rules/promotions/programs by adding, subtracting, or swapping out templates. As merchant administrators gain experience with the system, they may choose to create their own promotions/programs entirely on a custom basis. To build the preset the MA selects an element of grammar, then a template. For target templates, the operators “AND”, “AND NOT”, “OR” and “AND NOT” make the condition negative for its associated template. When “OR” is selected, the MA must let the system know how many templates to accept in lieu of the others, then define that number of templates. When the MA is done, he selects “THEN” as the grammar to move from defining target templates to behavior templates. All behavior templates are additive (AND is the only grammatical choice).

### EXAMPLE

A case study demonstrates the complexity and flexibility possible within the marketing toolkit, as follows:

An MA for Cooliage Petroleum wants to drive traffic to its CoolBrand stations during lunch hour. He wants to encourage cardholders to buy TexMex burritos (TexMex's UPC code is ‘1343101018’) for lunch because they have a good profit margin. However, one of CoolBrands regions, CoolWesternRegion, is doing very well between noon and 3 pm, so the MA wants to focus the promotion on the other regions. He also wants to offer an instant win sweepstakes for Platinum DV cardholders (rewarding with $100 in stored value and 1000 points). TexMex decides to sponsor this promotion and the MA has a budget for 1000 winners. The MA also would like to have a message printed on the receipt, and send an email to the winner letting them know that they won (just in case, they didn't get a receipt). Then, the MA wants to be notified who the winner was via email.

The rule would read:

If the product code of ‘1343101018’ AND it is a weekday between the times of 10 am and noon AND the scope is within CoolBrand AND NOT within the scope of CoolWesternRegion AND the system selects them as 1 out of 1000 winners AND the bundle group is Platinum Card Bundle THEN issue $100 in value to Stored Value Purse A AND issue 1000 point is loyalty purse B AND send email notification to ma@cooliagepetroleum.com “<name> has won the promotion at <store id>” AND send email notification “Congrats <name>, you have won Sweep-Burrito-Steak promotion. Your award has been added to your Platinum DV card. Remember, Cooliage Gas is the best gas.” AND print receipt message that says “Congrats <name>, you have won Sweep-Burrito-Steak promotion. Your award has been added to your Platinum DV card. Remember, Cooliage Gas is the best gas.

The preset would have the following templates and grammar (in the same order as presented above). AND <Product Code Template> AND <Date-Time Template> AND <Scope> AND NOT <Scope> AND <sweepstakes/random select> AND <Group> THEN AND <Reward to Purse> AND <Reward to Purse> AND <Notification> AND <Notification>.

Risk Management Framework

The system has a capacity for a fraud toolkit that provides the risk management framework to handle fraud detection on behalf of the merchant. The fraud toolkit 38 uses target and behavior templates to govern the rules engine during transaction processing. These types of templates differ from those used for defining marketing promotions/programs in that they may trigger system level defensive behavior. For example, the fraud targets may be things that expose the merchant to fraud risk and, as a result, the specified behaviors may be limited to internal actions, such as sending notifications to administrators of suspicious activity or restricting the transactions from being processed. The fraud toolkit could be managed by the system administrators 39 for the system-based service, or by the merchant directly. The fraud administrators manage access to the toolkit and system settings on a per merchant basis.

Presentation Interfaces

The presentation interface 30 provides Web-based interfaces for both merchant and cardholder interaction 37 with the system. All that is required to expand the presentation interface for connectivity to new, external devices is the development of a specific plug-in module for the universal translator. The presentation interface, as with the real-time messaging interface discussed earlier, uses the universal translator software to convert different incoming data to the standard XML format on which the platform runs. The marketing toolkit and fraud toolkit are all accessed through the presentation interface. Merchant system administrators use software inside the presentation interface, called the system control panel, to configure the system, set user/group permissions, and view reports generated from the transaction data stored by the system. Customer service representatives may view, modify, and manage user account information from their own interface. In addition, the presentation interface provides Web access for cardholders to register, load, view online statements, and check balances for SVC products and loyalty award promotions/programs.

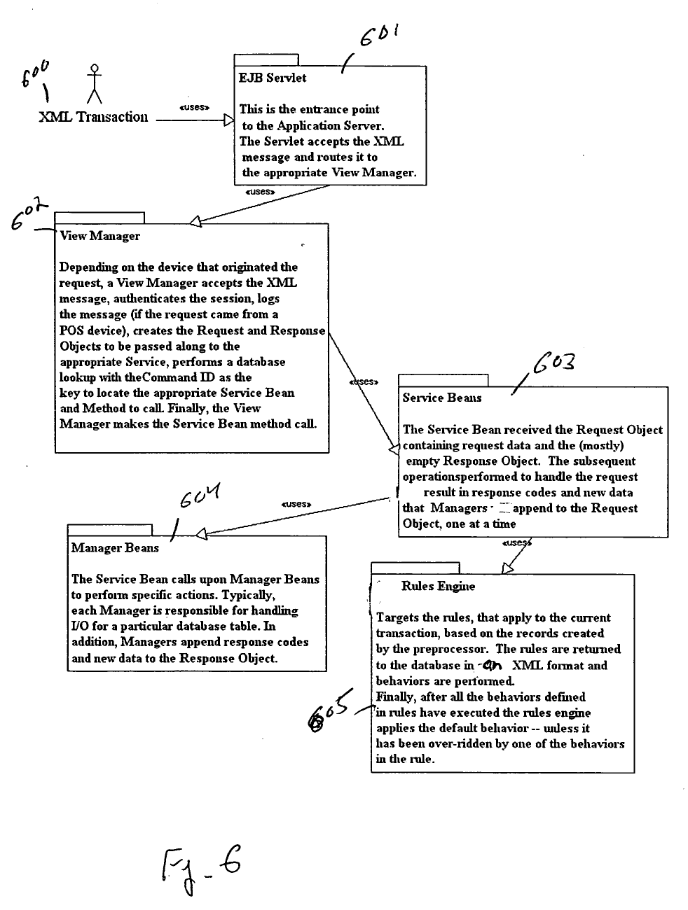

FIG. 6 is a flow diagram that shows an object/package model for transactions according to the invention. In the example of FIG. 6, the process begins with an XML transaction 600 that uses an EJB servelet as an entrance point to the application server 601. The servelet accepts this XML message and routes it to the appropriate view manager. The view manager is invoked and, depending on the device that originated the request, the view manager accepts the XML message, authenticates the session, logs the message if the request came from a point-of-sale device, creates the request and response objects to be passed along to the appropriate service, and performs a database hookup with the CID as a key to locate an appropriate service bean method to call 602. Finally, the view manager makes the service bean method call. The service makes calls to the other services and managers that perform specific processing duties, passing along the request/response objects in addition to any data wrappers returned to it by managers. The service beans receive the request object containing request data and the substantially empty response object. The subsequent operation performed to handle the request results in response codes and new data that managers append to the request object, one at a time 603.

The service beans use manager beans by calling upon them to perform a specific action 604. Typically, each manager is responsible for handling I/O for a particular database table. In addition, the managers append response codes and new data to the response object. The service beans also use the rules engine 605. The service beans target the rules that apply to current transaction based on records created by the pre-processor. The rules are returned to the database in an XML format and behaviors are performed. Finally, after all of the behaviors defined have been exhibited and the rules have all executed in the rules engine, the rules engine applies the default behavior unless it has been overridden by one of the behaviors in the rules.

Application Programming Interface

The API provides a framework for the merchant or merchant partner(s) to deposit cash or issue points and/or rewards within the system. The API is a real-time messaging system that allows merchant or merchant partners to develop custom solutions. With the API, the merchant has more control and processes can be more effectively controlled on a per user basis. The system-based service administrator must provide access to the API. Through the Web interface, the system-based service administrator hosts IP address(s) and the host must also have one or more user(s).

For example, an automotive manufacturer (sponsor) could use a gas station (issuer) to fulfill a rebate on a new car. With the purchase of a new car, the manufacturer using a custom application, sends a message activating a specific gas merchant's loyalty card and issuing $1000 in value good only for gas at that merchant.

The amount, restrictions, and almost any other aspect of a transaction can be controlled by the manufacturer's custom application. The toolkit is a Web interface for the MA that provides same capability for bundles, lists or all cardholders. This makes it quick and easy for an MA or customer support to fund cards without the overhead of custom development.

Future Modules

The preferred embodiment is expandable and customizable, and thus comprehends various future modules 40 forming a part of the common systems, which support custom integration 41.

Card Setup and Configuration

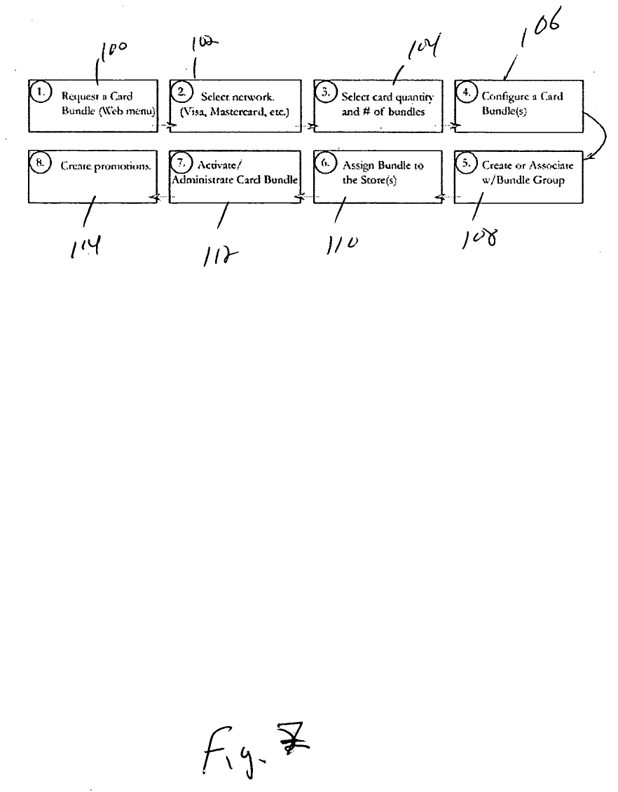

To set up a closed system payment card product the merchant administrator must do the following (see FIG. 7):

1. Cards are always assigned to stores in bundles (100)

2. Create bundles for a selective network (open/closed system) (102)

3. Create bundle groups and assign products to it (Loyalty/SVC)

4. Define bundle group properties, such as: Card denomination value (if appropriate); Whether the card is one-time use only, such as a gift card, or if it can be reloaded; Maximum account limit; and Minimum activation amount (104, 106, 108)

5. Define purses and types for each product 6. Assign card bundles to stores (110)

7. Activate/administer the card bundles (112)

8. Create promotions (114)

System Technology

All of the components outlined herein work together in a system designed for maximum reliability, speed, flexibility, and cost containment. The system owes its flexibility to the technology that drives the rules engine. The rules engine allows new products and toolkits to be added without the platform changing, i.e. data-mining/CDMS, Smart Cards, etc. While merchant administrators manipulate user interface components, such as templates and constraints to form promotions/programs, the underlying system compiles the rules into software objects to control processing. The rules engine provides an environment in which these logic and control processing objects interact. Because software objects serve as primitives, or basic building blocks, for defining loyalty promotions/programs and payment products, rather than using hard-coded rules, they may be combined in endless ways. The result puts tremendous flexibility in the hands of users and system administrators. It allows them to modify system and product functionality without requiring additional expensive and time-consuming development to deal with changing merchant business requirements.

Loyalty Product

The platform provides the functionality for merchants to issue loyalty cards to customers (FIG. 1; 14). These loyalty cards provide the basis for the merchant to offer highly personalized and custom loyalty promotions/programs to all or segments of their customer base. The loyalty reward product is designed to be a turnkey promotion/program that enables the merchant to begin offering their own loyalty product with little effort or systems integration, beyond terminal software. The merchant acquires new members by communicating advantages of having a loyalty card. Once a cardholder accepts a new DV card at a location, the account is activated at the POS, the cardholder signs up for program, and loyalty award operation begins for the associated account.

Household Links

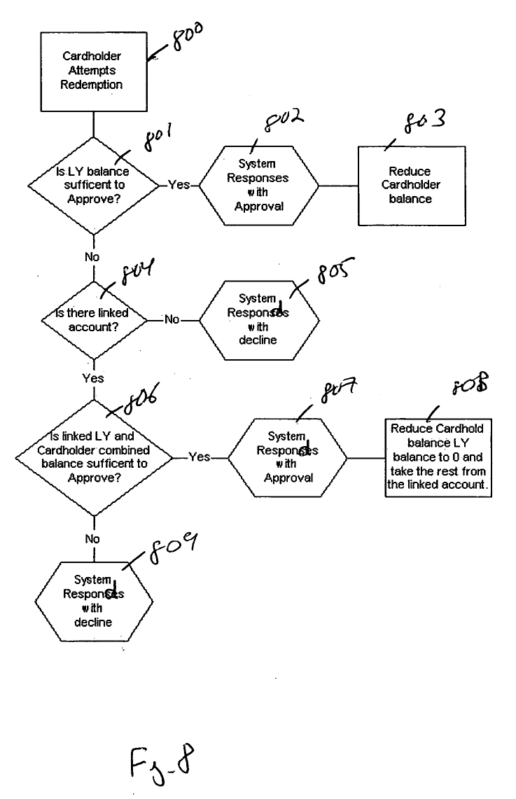

FIG. 8 is a flow diagram that shows household links according to the invention. At the start of the process, a cardholder attempts a redemption 800, and a determination is made to see if the balance is sufficient for approval 801. If the balance is sufficient, then the system responds with an approval 802, and the cardholder's balance is reduced 803 accordingly. If the balance is not sufficient, a determination is made whether there is a linked account 804. If there is no linked account, then the system responds with a decline message 805. Otherwise, the linked balance and the cardholder account are combined and a determination is made whether the account balance and the linked account balance are sufficient to achieve an approval 806. If so, the system responds with an approval 807, and the cardholder's balance is reduced to zero for the first account, with the rest of the amount being taken from the linked account 808, in which the balance is adjusted appropriately. Otherwise, the system responds with a decline message 809.

The product can be setup to allow a household group of consumers, in which each has his own loyalty card and purses, to redeem the points earned by the group. This enables loyalty reward promotions/programs that invite families to participate as a unit. This is called the household links feature of the platform. Household links can be setup during registration or on the Web site.

Administration

Merchant administrators can set up specific loyalty card promotions/programs for groups of cardholders using the marketing toolkit. The security manager subsystem controls the permissions for allowing certain types of transactions. Merchant administrators define the fundamental behaviors of promotion/program by creating rules. These rules allow the operator to set parameters for promotion/program features, messaging options, rewards options, and registration options. In addition to setting rules, card bundle configuration information may be supplied to define miscellaneous items such as multiple loyalty account purses and tables of messages that may be printed out on receipts. Once the products have been established, the MA can then set up promotional programs governing the rules engine using the marketing toolkit or templates.

Loyalty Programs and Promotions

Through the marketing tool kit, the merchant administrators create and manage rules/promotions. The system can respond to any combination of consumer behaviors that can be tracked during a transaction.

Templates

Target Templates

Product code templates: Purchase of targeted products and/or quantities of targeted products. Examples: UPC, NACS or any code less than or equal to 16 characters or digits.

Equality: Product code template where the product code defined in the template matches those defined in the transaction.

Quantity: Defines the product code and the quantity.

Frequency: Template defines a particular product and the specific number of times purchased within defined span of dates.

Amount: Defines the amount of purchase exceeds or meets the defined amount.

Scope ID templates: Purchase from within a defined scope, i.e. a particular store, region, division, brand, client or coalition.

Date/Time (Temporal): Targeted behaviors are performed when transactions are within a defines a span of dates.

Business Code: The template defines the business codes that may be sent by the point-of-sale or other device to be used in rules. A business code tells the system the merchant's category of business, i.e. Liquor, weapons, Adult material, etc.

Accumulation/Threshold: Allows points to be issued either based on balance or amount of points earned.

Frequency: Allows the promotion/program to execute at specific intervals.

Instant Win (Sweepstakes) selection template: MA's can define the type of rewards and the number of each type. These rewards are given randomly to users that meet the other action template requirements.

Pre/Post-Authorization and Participation/Sale Allows promotion/program to behave differently based upon authorization types.

Grouping: Scope may be defined in the promotion/program by product, bundle group and card bundle. This template is mandatory, because the rule must have product(s) or subsystems to effect.

Behavior Templates

Messaging templates: The merchant has the capability to drive messaging to cardholders through various points of interaction, based on one or more action templates.

Custom Messaging (Product): Using simple text tags custom messages can be define for printing on the receipt. If combined with a Product Code action template it can issue a product message. For example: “Hello <First_Name><Last_Name>, thanks for buying Coke!” This is printed as, “Hello John Doe, thanks for buying Coke!”

Greeting: MA may customize the greeting to the user using a format similar to the custom messaging template.

Point Messaging: MA may select any combination of Lifetime Point Total, Current Point Total, and Sale Point Total.

Discount/Coupons template: Discount coupons maybe issued either at the point-of-sale device and printed coupons for later use or against the current transaction (in real-time). This template can also be used to issue prizes or sweepstakes awards.

Reward to purse template: Allows the MA to issue rewards of points, products and/or cash for any action or set of actions to a specific purse.

Points for Spending template: This template allows the MA to issue points based on amounts spent.

Points for Gas Quantity template: This template allows the MA to issue points based on the amount of gas purchased. These templates define the program, promotion, or product logic that make up the desired operation. If a MA uses preset templates from the marketing toolkit for a particular kind of promotion, all that remains for the MA to do to make the promotion/program active is to set the appropriate values driven by the target (or action) templates.

For example, some of operations available as parts of the loyalty promotion/program are as follows:

Increment loyalty points as the consumer makes purchases;

Decrement loyalty points as the consumer redeems them for something of value;

Decrement loyalty points as the consumer cancels all or part of a purchase transaction that previously resulted in an increment of loyalty points;

Return a discount authorization to the point-of-sale via the acquirer's host when the cardholder's loyalty account reaches a threshold amount;

Enter a cardholder into sweepstakes contests;

Notify a cardholder of loyalty account balance;

Convert loyalty points into gallons dispensed at a CRIND/ICR;

Return promotional messages to point-of-sale and CRIND/ICR terminals personalized to a particular user or to a consumer profile.

Cardholder Registration

Members can sign up for these products in numerous ways, for example:

Fill out a paper form with registration information and submit it to a merchant employee or mail it in. These orders are processed via a batch file or 3rd party API;

Provide information to a point-of-sale operator for instant registration;

Call the merchant's CS department and provide the information over the phone;

Fill out a Web-based form at the merchant's Web site (Instant Opening);

Interact with a kiosk (instant account activation).

Multiple issues can also be made via a batch process.

Anonymous accounts depend on the card as the sole authentication and identification for the loyalty member. Anonymous cards may be activated by the merchant at the point-of-sale or may be activated in batch for distribution by a third party. Third parties maybe a vendor, distribution partner, or for internal use. Cardholders identify themselves using their card number and PIN. The loyalty member is able to maintain their anonymity and the merchant is still able to collect data, and build cardholder profiles and tracking buying patterns.

Merchant Coalitions

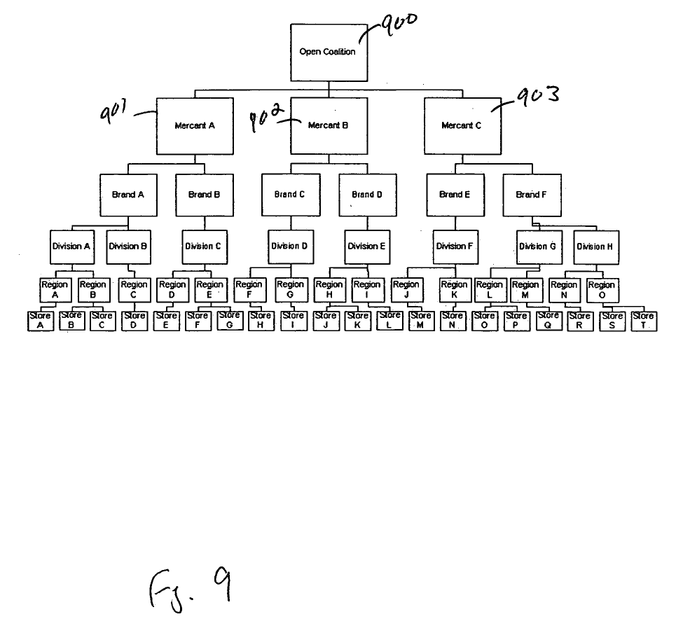

Merchants may form coalitions to share a promotional program(s) across businesses. For example, FIG. 9 is a block schematic diagram that shows an organizational structure beginning with an open coalition 900 comprised of merchants A-C, 901-903. Each merchant maintains respective brands (brands A-F) with the brands being associated with a particular division or divisions (divisions A-H). Likewise, the various divisions are associated with geographic regions (regions A-O) where each region contains within it one or more stores (stores A-T, respectively). All of the merchants must be participants in the system-based service dynamic value program to make this possible.

There are two types of coalitions: standard (closed) and open. The division between open and closed is based on the ownership of the cardholder account. In a standard (closed) coalition the accounts are owned by each merchant separately, and the merchant is the issuer.

In an open coalition, the coalition owns the accounts and the coalition is the issuer. Coalition participants create a special type of merchant account that grants permissions for viewing reports and controlling rules/promotions in accordance with the nature of the joint business relationship. For example, a group of merchants could all agree to promote a rewards program that is offered to all of the participating merchant cardholders. Standard (or closed) coalition links provide templates that allow one merchant to issue points and/or rewards within another merchant's promotion/program, given both agree to participate. In this case, there may be no coalition promotion/program, just a merchant who wants to offer another merchants points. This is done today when a merchant promotes the ability to earn airline miles based on specific behavior while the airline does not promote the merchant to its cardholders.

In a standard coalition, each merchant owns its cardholder relationships separately.

The system-based service system administrator configures the permissions for a merchant's account so that loyalty points may be awarded to cardholders belonging to a different merchant's loyalty promotion/program. In open coalitions, each merchant can control their own rules/promotions. They inherit all the rules/promotions that are defined by the coalition. This is one account: Any divisions are based on rules and may be changed. In an open coalition, the coalition owns the cardholder relationship. Rules/promotions from the coalition are senior and in addition to any a merchant may define on their own. Points are accumulated, redeemed, and accounted for centrally, unless a merchant sets up a restriction for purse making it only good for just that merchant or a particular store.

A variant of an open coalition is one in which the merchants in the coalition do not own the cardholders. Rather, a third party owns the account and the merchants are just participants. This solves many of the problems associated with account ownership for open coalitions. The merchants can be added and removed at the third party's description. When a merchant is removed from the coalition they have no cardholders. The coalition retains ownership of all the accounts. This third party could be an airline, manufacturer, service company, or a network that specializes in loyalty.

A few observations about choosing between open and closed coalitions:

Do accounts need to be shared across merchants?

Open Coalitions: Both sharing and earning value across merchant is implied. All accounts and purses are set at the coalition level.

Closed Coalition: Accounts are not shared in closed coalition.

Is the coalition temporary, changing or not part of the merchants' long-term strategic plan?

Open Coalitions: Are difficult to leave if a merchant should decide to leave. This is a consideration if merchants involved do not object to be working together over the long term. It is also difficult to transfer cardholders to an open coalition should a merchant change its mind after issuing cards outside the coalition.

Closed Coalitions: Are just links to cardholder data. They are far easier to remove or modify.

Is the functionality between merchants simple and limited?

Open Coalitions: Allow for very tight almost transparent functionality between merchants. Implementations can be complex, easy to configure, and less limited.

Closed Coalitions: Allow for very loose and temporary links between merchants.

API

Funding is supported in the platform across all the products with a common API. A client or their partners may fund accounts in real-time from their proprietary systems in points and non-monetary values, i.e. airline miles. Within the marketing tool kit, the merchant can fund points to selected cardholders or to all cardholders. Cardholder lists maybe loaded into to the system and saved for later use. To issue points, the MA just selects the appropriate list and sets the funding amount.

Phantom Fee

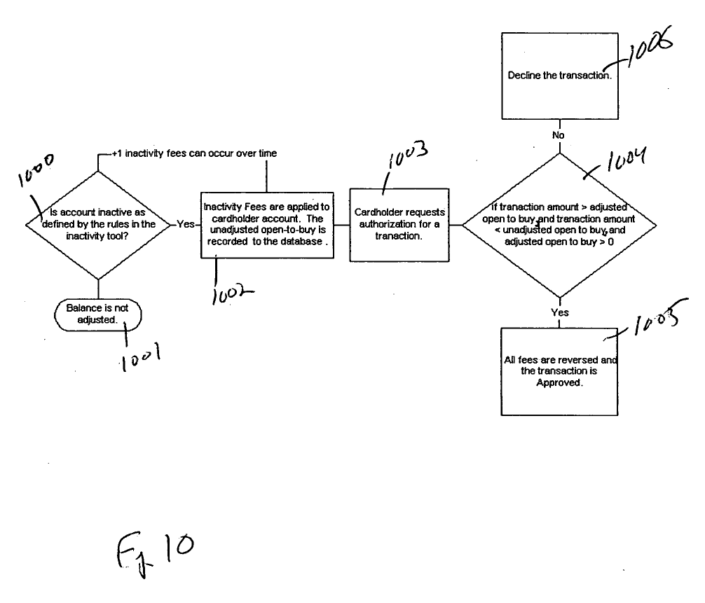

FIG. 10 is a flow diagram which shows a phantom fee arrangement according to the invention. The phantom fee arrangement allows an inactive account to be revived and to have inactivity fees reversed upon use of the account within a merchant determined period of time. In the phantom fee arrangement, a determination is made if the account is inactive as defined by the rules in an inactivity tool 1000. If the account is active, then no adjustment is made to the account balance 1001. If the account is inactive, inactivity fees are applied to the cardholder account 1002. Inactivity fees can occur more than once over a period of time. The unadjusted open-to-buy value is recorded to the system database. At some point before the account is closed, the cardholder may request authorization for a transaction 1003. If the transaction amount is greater than the adjusted open-to-buy amount but less than the unadjusted open-to-buy amount, and the adjusted open-to-buy amount is greater than zero 1004, then all fees for inactivity are reversed and the transaction is approved 1005. Otherwise, the transaction is declined 1006.

The Closed System Stored Value Product

There are two basic types of stored value cards: closed system (FIG. 1; 16) and open system (FIG. 1; 18). Usage of closed system cards is restricted to the merchant or merchants who have implemented the card. For example, gift cards and other one-time use stored value cards are typically restricted to purchases from the issuing merchant only. A closed system payment card can also be used to implement a loyalty-only promotion/program by offering promotions that are triggered by use of the card in an eligible store. The closed system stored value product provides the loyalty promotion/program described in the previous section with the added functionality of being able to load cash value to the payment cards and use them for purchases within the merchant stores. Depending on the rules set by merchant administrators, consumers may load their cards directly through Web interfaces, at the point of sale, alternatively merchant administrators may preload cards with value as bulk transactions before sending them to merchants.

Closed System Stored Value Features and Promotions

As with the loyalty reward product discussed above, promotions controlling the functionality of the closed system stored value cards in response to cardholder behaviors are built out of templates. Promotions for stored value cards may award a real-time product discount when the cardholder activates and loads the card, award loyalty points for using the card at stores belonging to the merchant's chain, and enable merchants to issue stored value cards that block purchase of certain items, or block any purchase from a merchant that sells certain items. As with loyalty promotions/programs, the closed system stored value card product provides marketers with a powerful tool for enhancing a payment product with promotional awards. Stored value may be funded with credit, debit and/or cash at the point-of-sale. All funds are immediately available for the cardholder. The Web interface supports funding by credit, debit, and checking. A merchant may support one or more of the available funding types on the Web.

Closed System Stored Value Card Templates

The platform supports single-swipe cards that combine the capabilities of both loyalty reward cards and payment product cards. The following templates and other features examples:

Action Templates

Product Code Grouping Template: Allows groups of product codes to be loaded into the system and used in promotions as a group.

Transaction Templates

Equality: Defines transaction types to execute behavior template upon transaction type

Frequency: Targeted behaviors are performed if the consumer makes specific type of transaction a defined number of times within defined span of dates

Amount: Causes the system to execute behaviors when amount of purchase exceeds or meets the defined amount.

Card ID template: Cardholders, such as VIP's, may be assigned to groups that enjoy special discounts and other benefits in response to targeted behaviors

Card Status template: First-time users of loyalty and/or stored value cards may receive additional benefits, such as loyalty point awards

Behavior Templates

Decline Transaction: Causes a transaction to be declined when the rule executes.

Loyalty Point Conversion Template: Merchant may set a cash conversion amount for redemptions that involve translating points to cash.

Notification: Defines email notifications that maybe sent based on action templates.

Notifications use the same tags as the custom message template for customization. Notifications maybe used for internal notifications or to notify the cardholder via email

Purse For Transaction

The MA may select which purse to use for a rule/promotion. Loyalty points may be redeemed, for example, for cash or stored value on a prepaid card at a kiosk in a closed environment. This card receives its value from the loyalty point conversion template. With the cardholder Web interface users can register, communicate with cardholder support via email, fund their accounts (optional), and view electronic statements. Email advertising is added to the marketing toolkit. This feature enables merchant communications via email to all or part of their cardholder base. The emails may be customized using the same text tag format as the custom message template.

Community Links

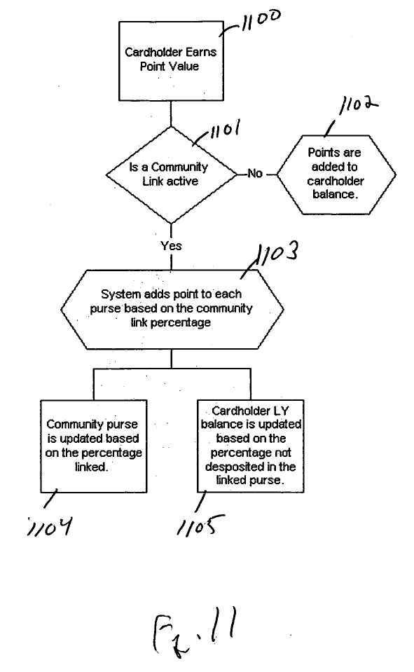

FIG. 11 is a flow diagram which shows community links according to the invention. In this embodiment of the invention, a cardholder earns a point value 1100, and a determination is made if a community link is active 1101. If the community link is not active then points are added to the cardholder balance 1102. Otherwise, the system adds a point to each purse based on the community link percentage 1103. The community purse is updated based on a percentage link 1104 and the cardholder balance is updated based on the percentage not deposited in the link purse 1105.

Cardholders may assign value earned in a purse to a community purse. Only the community purse cardholder can redeem against that purse. Users subscribe to this via a Web interface.

A few facts about community links:

Registration by cardholder indicating the community purse and the percent of points to be placed into the community purse. If the cardholder has more than one loyalty purse from which points can be given the cardholder identifies the source purses.

Points are issued at the time of the transaction.

The points issued to the community purse may be reflected on the receipt depending on the capabilities of the POS system. The DV system makes the points for the transaction for the community purse available for the receipt.

The community purse owner does not see who placed points into the community purse. Because the merchant sponsor can see all of the transactions, the merchant sponsor knows who placed points into the community purse.

The cardholder should have the capability to transfer points from their purse(s) to a community purse.

The cardholder can establish what the total amount of the contribution is and/or the duration of the contribution. This automatically discontinues the contribution when the established threshold and/or duration are met. Third Party fulfillment allows coupons and certificates to be mail by a third party fulfillment center.

Multi-Value Purses

Merchants can set up card groups that have multiple purses, and they may be added at any point. Purses are defined in the marking toolkit. When a purse is defined each it has the potential to hold value for every card under an open coalition. However, a purse is not created unless value is deposited onto the purse. These purses can have limited use or may be restricted to a particular part of the merchant/coalition scope. All purses are defined at the highest level of the merchant scope and purses can be added at any time. While rules may restrict the use of a particular purse, once the rule is removed the restriction disappears.

Statements

A statement comprises all information pulled for a date range for a single account or a set of household accounts. A statement is available online, via batch, and through the API.

Open Network Stored Value Loyalty Card

The open network branded stored value card offers the functionality of the loyalty product and the closed system stored value card, while allowing the card to be used with any merchant that accepts major bank cards for payments. Because open system card transactions travel over the Visa®), MasterCard®, and other networks, the transactions are ultimately routed to the platform for authorization and processing. Merchants have the added ability to apply promotions to open system payment card transactions by defining target templates that do not rely on store location or product ID information. For example, a merchant may create a rule to decline a purchase based on business code. The merchant can also create promotions that are applied when the open system card is used at one of its own stores, in which case the promotions are not applied when the card is used outside of the merchant's chain of stores.

Auto-Replenish from checking (ACH), credit and/or debit schedules the deposits to the stored value card. This feature is available from the merchant's Web site. Another cardholder may also do scheduled funding for an existing cardholder. The open system card may withdraw funds from ATM networks supported by the system-based service. PIN and message encryption are added to increase security and support ATM authentication.

Open System Stored Value Card Templates

Additional functionality is made available with the open system product and can be made functional using the following templates:

Behavior Templates

Drawing Sweepstakes template: Winners may be notified in real-time or contacted later, if registered. This is mainly a reporting feature for sweepstakes winners. The actual awards whether cash or products are issued using the coupon template.

Pump Discount Template: Resets the dollar amount for the price per gallon at the CRIND/ICR. This price change in only active during one purchase.

Multiple Registered Card Links

Loyalty members may register credit/debit cards and other forms of identification. For example, the system accepts identifiers such as key fob, drivers license, mCommerce, student ID, etc. This allows a combined loyal and payment transaction for cards that are not associated with the merchant or system-based service. These links can be set up at on the merchant Web site, point-of-sale, or CRIND/ICR. In addition, multiple payment cards may be linked to one loyalty account.

### Users and Groups

Users and Groups Introduction

Anyone interacting with the system is a user. Users are always assigned to an organizational abstraction called a group. Groups have two attributes: what its members can do (operations), and the access level to which it belongs (scope). Users are restricted to membership in one group. The system enforces this rule by ensuring that each login name is associated with one group. However, a user may optionally belong to a no-op group, i.e. a group having no operations. In effect, this is a read/view only group for it's scope. Everything the system can do, from displaying reports to letting merchant administrators create marketing promotions/programs, is an operation. Even displaying a particular menu in a Web-based GUI is considered an operation.

There are three special types of groups: system superuser (SSU), merchant superuser (MSU), and cardholder. SSU members have unrestricted access to all operations available to the platform. MSU members have unrestricted access to all operations affecting the merchant/coalition account under their control. MSU members cannot perform operations on other merchant/coalition accounts.

Operations

Each operation has two attributes: what it does, i.e., its function, and a minimum scope level setting required of the user to perform the operation. The list of operations and required scope levels are maintained in a database table. Operations are grouped together into an organizational abstraction called a family. Families exist to simplify the task of assigning hundreds of system operations to groups. Administrators typically refer to a family of operations when setting up a group, rather than having to set permissions for rules one at a time. For example, the “Marketing Operations Family” might include marketing-related operations such as “Create Marketing Promotion/Program” and “View Marketing Report.”

A family may consist of dozens of individual operations. When a member of the MSU Group sets permissions for a variant of a predefined marketing group, setting permission to use the “Marketing Operations Family” allows the group members to access dozens of individual operations.

There are two types of settings for families: ‘Yes’ and ‘No.’ If a family is set to ‘Yes,’ then the Group members may use any operations that belong to that family. If a family is set to ‘No,’ then the group members are not permitted to use any operations that belong to that family.

Permissions for operations listed within a family may be set individually as well. There are three types of settings for each operation listed within a family. If a family is set to ‘Yes,’ then each of its operations is set to a permission setting of ‘Yes.’ If a Family is set to ‘No,’ then each of its operations is set to a permission setting of ‘No.’ In some cases, an MSU might assign a few Operations from a family set to ‘No’ to a group by setting those operations to ‘Hard Yes.’ A ‘Hard Yes’ setting on an individual operation overrides a ‘No’ setting for its family.

Scope Permissions

Operations affect an organizational abstraction of merchant/coalition scope called an item. Scope levels define the scope of items that may be affected by an operation available to a group. Members of the group may perform operations on items within or below the scope of the group's assigned scope level. For example, a merchant administrator group with a scope level of region may perform operations that affect a region of stores as a discrete entity, thus affecting all stores belonging to that region. However, none of the group's members are allowed to perform operations on any items belonging to another merchant's account. The platform authorizes users to carry out operations by comparing the scope level settings of the user's group to the minimum scope level required to perform the desired operations.

The platform provides the following scope levels:

System

Open Coalition

Merchant

Brand

Division

Regional

Store

System Scope

This setting enables the system-based service and the system administrators to perform operations that affect any item belonging to any merchant/coalition account. System scope, combined with permission to perform any operation available to the platform, gives SSU members unrestricted access to all areas of the system. SSU group and system-based service CSR group have a system scope.

Open Coalition Scope

This enables MSU members to perform administrative tasks affecting all bundle groups, Card bundles, promotions, users, and groups associated with the coalition. Some CS representatives are granted coalition scope permissions, though the operations available to their group are restricted to those necessary for resolving cardholder issues. All accounts and purses are created and available at this level, but can be restricted using rules.

The following are always scoped to coalition and may be restricted another within the rules engine:

Bundle Groups

Card Bundle

Cards

Purses

Merchant Scope

Group members with merchant scope may perform operations that affect all brands, divisions, regions, and stores assigned to its merchant scope. MA group members with merchant scope may not create promotions that affect stores in that are not under their scope.

Brand Scope

Group members with merchant scope may perform operations that affect all divisions, regions, and stores assigned to its brand scope. MA group members with brand scope may not create promotions that affect stores in that are not under their scope.

Division Scope

Group members with merchant scope may perform operations that affect all regions and stores assigned to its division scope. MA group members with division scope may not create promotions that affect stores in that are not under their scope.

Regional Scope

Group members with merchant scope may perform operations that affect all stores assigned to its regional scope. MA group members with regional scope may not create promotions that affect stores in that are not under their scope.

Store Scope

Group members with store scope may perform operations that affect specific stores. All cardholder accounts are associated with specific stores or pseudo-store via card bundles.

Item Instances

Any group with an access level below that of SSU must be assigned one or more instances of the regions or stores that the group's members are permitted to control in the same scope. In the case of the MSU group, only one instance need be defined, i.e. the merchant account administrated by the MSU group's members. Groups with lower scope permissions are assigned to certain stores or regions within their scope level.

### EXAMPLE

Bob is a regional manager for a store chain. He belongs to a group with regional scope, and his group is assigned two regional instances: Northern California and West Virginia. Therefore, Bob may perform operations affecting any stores within those two regions. One year after Bob is assigned to his group, he is given control of the Southern California region. A member of the MSU group must change the regional Instances associated with Bob's group by adding the Southern California region to the group's other assigned Instances.

Predefined Groups

The user interface for MSUs provides a set of redefined groups. In addition, members of the MSU group are allowed to define their own groups. A predefined group consists of a list of operations available to the group members and an assigned scope level. MSUs may not create groups with scope levels higher than their own. The system does not limit the types of operations that may be assigned to groups, i.e. an MSU group member may give a regional level CS representative the ability to create marketing promotions/programs. Using predefined groups helps minimize misuse of the system. The system-based service may delegate use of these predefined groups so that all clients may use them to create users. Examples of predefined groups include: store level MA, MSU, regional level MA, regional level CSR, cardholder, and SSU.

The System Administrator

The system administrator belongs to the SSU group.

The following operations are provided for this user via the Web-based system administration panel:

Create coalition/merchant account or closed coalition links between coalition/merchant accounts.

Enter profile information for all MSU users.

Assign users to the MSU group.

Activate/suspend all platform operations associated with the merchant or coalition.

Add new merchant accounts to an open coalition.

Configure individual merchant account settings to allow for certain promotional operations that affect other merchant account items (closed coalition).

View system server logs and error logs.

The Merchant Superuser

The merchant/coalition superuser belongs to the MSU group.

The following operations are provided for this user via the Web-based system administration panel:

Enter profile information for all MA users.

Assign/reassign users to the MA groups.

Activate/suspend groups and users.

Modify group operation permissions and scope settings.

Create new group types by modifying preset or previously stored group configurations.

Enter settings about the specific capabilities of the merchant's point-of-sale terminals.

Set rules governing maximum risk levels allowable for any card bundle created by an MA.

Set rules that supply default values for MAs creating card bundles.

The Merchant Administrator

The merchant administrator belongs to the MA group.

The following operations are provided for this user via the Web-based marketing toolkit:

Create/activate/suspend card bundles.

Set card rules pertaining to risk.

Set card rules pertaining to non-promotional behaviors.

Create/activate/suspend promotions.

View reports pertaining to cardholder demographics, aggregate account information, card bundle details, and other transaction-related data collected by the platform as it processes transactions.

View rules in a affecting the current scope.

The Customer Service Super User

The customer service super user belongs to the CS group.

The following operations may be provided for this user via the Web-based customer service panel:

Enter profile information for all CS users.

Assign/reassign users to the CS groups.

Activate/suspend groups and users.

Modify group operation permissions and scope settings.

Create new group types by modifying preset or previously stored group configurations.

Enter settings about the specific capabilities of the merchant's point-of-sale terminals.

Modify cardholder profile settings and account values.

Suspend cardholder accounts.

The Customer Service Representative

The customer service representative belongs to the CS group. The MSU administrator or the customer support super user determines the operations available to the CS representative. In some cases, the MSU may permit CS representatives to modify card bundle settings.

The following operations may be provided for this user via the Web-based customer service panel.

Search for cardholders in the database.

View cardholder profile and account information.

Modify cardholder profile settings and account values according to permissions set by CSSU administrators.

Suspend cardholder accounts.

Perform point-of-sale/terminal operations on behalf of a point-of-sale operator in case the store's network connection to the acquirer's host is down. An approval code and check digit is generated.

Retrieve a card number from the database to order a replacement.

Submit reports of anomalous system behaviors.

List card bundles and bundle groups.

View rules all rules in the system.

List store addresses.

List transaction details within their group's scope level and instance settings.

The Cardholder

Cardholders are free to perform any operations that pertain to the card bundle permissions set by the MA.

These operations, made available to the cardholder from a Web-based user Interface, may include the following:

Register for an account.

Request additional cards.

Add other members to the account.

Suspend other members from using the account.

View account transaction reports.

Activate a card.

Load a stored value card.

Replenish a stored value card.

Modify account.

Merchant/Coalition Accounts

Merchant/Coalition Accounts Introduction

Every merchant client participating in loyalty promotions/programs and payment products has one merchant account.

Default Type

The default type of merchant account restricts operations to specific Items, such as card bundles and promotions, belonging to the account. Operations may not affect items belonging to other merchant accounts, unless other merchants are added to the open coalition scope. Each merchant automatically belongs to an open coalition even if it is the only member.

Open Coalition Usage

Any merchant member of the open coalition may participate in the card bundles and promotions created for the account. All users with sufficient permissions may view reports presenting data from card use at any participating merchant's stores. Once a merchant has a cardholders and transaction history it must be manually added to an open coalition.

Closed Coalition Type

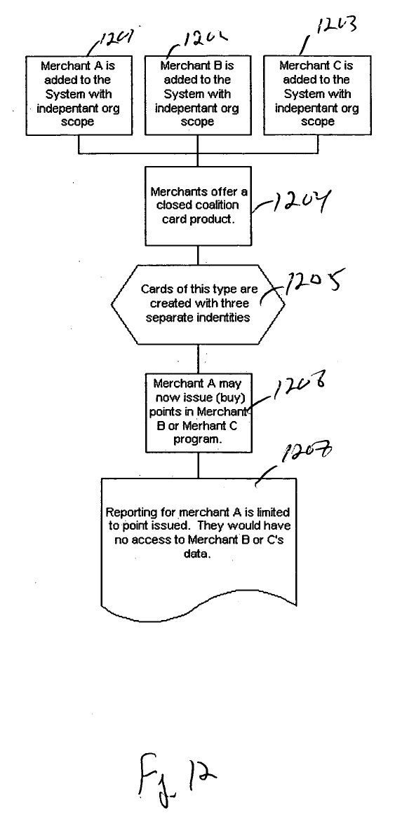

FIG. 12 is a flow diagram which shows a closed coalition according to the invention. In this embodiment of the invention, merchants apply and merchants are added to the system with an independent organizational scope 1201-1203. The merchants thereafter can offer a closed coalition card product 1204. Cards of this type may be created with any of three separate identities in the preferred embodiment 1205. A first merchant, merchant A, may now issue (buy) points in the merchant B (1202) or Merchant C (1203) program 1206. Reporting for merchant A is limited to the points issued 1207. Thus, merchant A has no access to merchant B's or C's data.

The system creates coalition bundle and assigns it to the coalition store for each merchant that participates in a closed coalition. The merchant who initiates the account, requests the system to create secondary account and creates a link with a primary account. This linking may occur simultaneously at account creation, later via a batch process, or manually by the user on the Web site. The system uses the link to issue points/value against the linked account. Neither merchant may view reports containing the other's transactions or cardholder data. If merchants agree to participate in such a program, one merchant's promotions may award loyalty points to another merchant's cardholder, as long as the cardholder is participating in both loyalty programs and the two accounts are linked at account creation. This allows the requesting merchant's “Issue Closed Coalition Points” behavior template's constraints to issue points to a loyalty purse belonging to a card bundle of the receiving merchant.

A merchant's promotion may still award cardholders with a coupon good for redemption at another merchant's store, if merchants are participating in closed coalition but cardholder accounts are not linked.

Merchant/Coalition Account Creation

The first step in creating a merchant account is for the platform SSU or another system-based service employee with the appropriate permissions to enter the following information from a Web interface. This information is loaded from a file the SSU upload, to the system from the Web interface or via CRON job:

Coalition/merchant name

Scope scheme (merchants, brands, divisions, regions, and stores) and respective terminal IDs and labels for stores.

List of product codes for merchant's inventories as used in promotions. Optional: Product codes may be defined with a rule.

Business type codes for merchants whose point-of-sale devices are capable of sending the appropriate message field data in a transaction message. Optional: business type codes may be defined with a rule.

Business codes are supported in all interfaces to the platform.

Merchant/Coalition Account Activation

The SSU member performs the following operations:

Enters the profile information for one or more designated MSUs:

1. User first and last name

2. User email address

3. User login name

4. User initial password

Assigns the Users to the MSU Group

Activates the Merchant Account

Sends the Users their initial login and password information

Merchant/Coalition Account Configuration

The MSU member performs the following operations:

Changes password.

Provides all client information, such as the store addresses and the merchant's headquarter address and phone number.

Updates personal profile information if necessary such as adding name, email, and phone info.

Merchant/Coalition Account Administration

The MSU member performs the following operations:

Enters the profile information for one or more MAs:

1. User first and last name

2. User email address

3. User login name

4. User initial password

Creates new types of groups

Assigns users to groups

Removes users from groups

Creates family of operations

Assigns permission to groups

Cards

Cards Introduction

Merchants issue plastic cards to customers participating in loyalty reward and payment product programs. Marketing program administrators assign business rules governing the capabilities of cards by defining card bundles and bundle groups.

Loyalty

Product bundle groups and card bundles can be configured to trigger loyalty promotion programs created by MAs working with the platform. Typically, a cardholder swipes his card during the payment transaction. The point-of-sale system sends the loyalty card account ID, along with a list of items purchased and related information to the acquirer's host, and from there to the platform. Once the card has been verified by the system, any loyalty operations set up by the MA are performed. These operations include, for example, sending a balance statement to the point-of-sale terminal, printing out a markdown coupon or promotional message on the receipt, discounting the purchase price on certain items, awarding points to the cardholder's loyalty award purse, and redeeming points accrued for something of value.

Multiple cards can be assigned to family members, thus allowing any one cardholder to redeem points earned by the entire group of cardholders.

A single card may contain one or more loyalty award purses. This enables MAs to implement promotions that award points to one purse for some behaviors and another purse for other behaviors.

When a purse is created, it is given a name. When the MA wants to assign value to that purse, base on a rule, they select that purse name as the one to receive value, using the reward value to purse template. Alternatively, the system-based service allows a purse to be defined in the transaction message.

Stored Value

A stored value card allows cardholders to pay for purchases from funds loaded into the card account. MAs set the business rules governing card usage, and the platform applies those rules against payment transactions. Depending on the properties set for the product, bundle group, and card bundle, the card may function as a gift card, i.e. one-time use only, as a reusable payment card that cardholders may replenish at a check-stand or from a Web browser, as a private label closed system payment card, and so on. A stored value card can restrict purchases based on product codes, the merchant's business code, and a store's location and purchase amount, or it can respond to cardholder usage with targeted promotional messages printed out on receipts.

Closed System

A closed system stored value card can only be used at stores belonging to the merchant/coalition issuing the card. Transactions do not use payment networks, i.e. Visa® or MasterCard®).

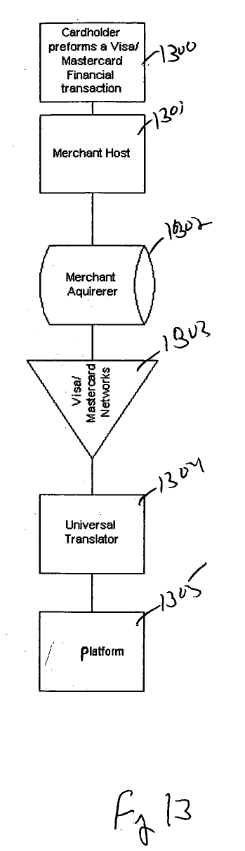

FIG. 13 is a flow diagram that shows an open system according to the invention. In this embodiment, at the beginning of the process a cardholder performs a Visa®/MasterCard®-type financial transaction 1300. The transaction is forwarded to a merchant host 1301, and then to a merchant acquirer 1302. The transaction travels the Visa®/MasterCard®) or equivalent networks 1303, and is applied to the universal translator of the system 1304. Thence, the transaction is processed by the system platform as discussed above 1305.

Open System

An open system stored value card may be used for purchases from any merchant connected to the Visa® or MasterCard® payment networks, either through system-based service or through other means.

Card Bucket

A card bucket is a sequential list of unassigned account/card numbers that is generated and verified by the SSU entering a bin range for a client or coalition. These buckets can be used to create bundles.

Creating Card Bundles

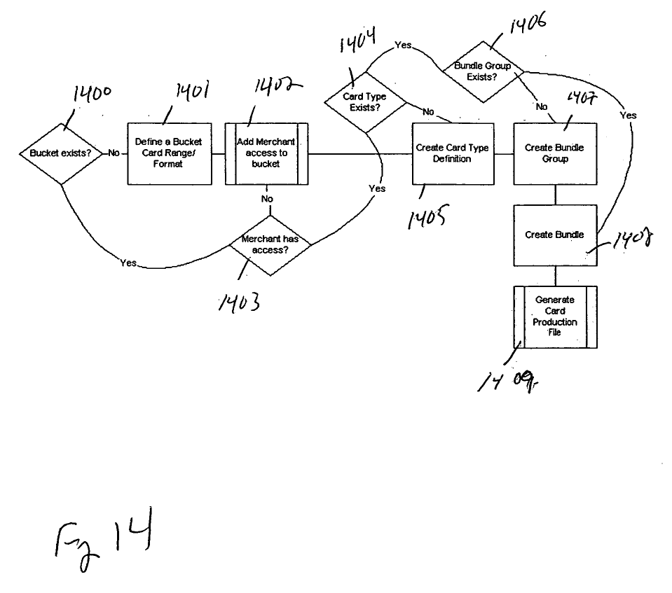

FIG. 14 is a flow diagram which shows a card bundled according to the invention. At first, a determination is made whether a bucket exists 1400. If not, then a bucket card range/format is defined 1401, and merchant access is added to the bucket 1402. If the bucket does exist, then the merchant already has access 1403. Next, where the merchant already has access a determination is made whether a card type exists 1404. If not, a card type definition is created 1405. If it does exist, a determination is made whether the bundled group exists 1406. If not, then the bundled group is created 1407. If it does exist, then the bundle itself is created 1408, and a card production file is generated 1409. In reviewing the flow shown in FIG. 14, it can be seen that if merchant access is added to the bucket 1402, then a card type definition is created 1405, and the process proceeds as shown in the FIG. 14.

MAs perform an ordered sequence of operations to implement card bundles:

1. Request a card bundle

2. Select network (open/closed system)

3. Select card quantity and number of bundles

4. Configure a card bundle: if multiple card bundles are being defined configuration must the same.

Access code indicator. Sets access code requirements for manual transactions

Options that allow/deny the following transactions:

Allow credit transactions—return credits to the card.

Allow inquiry transactions—balance inquiry and last transaction inquire.

Allow authorization transactions

Allow force draft capture transaction

Allow replenish transaction

Allow sale transaction

Location restriction—Sets restrictions for card usage to a specific location, scope, or no usage restriction

Pre-denominated value—Sets an amount for the card. Once set this amount cannot be changed at activation

Pre-authorization timeout

Card use indicator—An option my be set that the card can only be used for one sale that must total account balance, after which the card is deactivated

Cash account—Sets up a default cash purse

Credit account—Sets up a purse for returns

Account debit order—Sets the order that cash and credit purses are used

Allow anonymous registration

Create or associate card bundle(s) with a bundle group

Bundle group defines card type: stored value only, loyalty only, and integrated (stored value/loyalty)

Bundle groups allow merchant defined rules to target groups of bundles

Assign bundle to the store

Activate/administrate the card bundle

Bundle inventory reporting that allows MA's to browse the bundle inventory showing stores, card ranges, date ordered, embossing status, and date shipped

Create promotions using the card bundle or bundle group

System Response to Create Card Bundle Request

Upon submission of the information listed above, the platform:

Assigns a range of card numbers from a pool of available card numbers supplied by the acquirer.

When the cards are assigned to a merchant/coalition an entry is entered into the embossing table that the system-based service external process uses to create embossing file.

Next, the system inserts records pertaining to purses, card value, authorization limits, funding limits, card-history, inserts a card bundle record, and generates a card bundle ID, and then updates the card records with all card bundle rules set by the MA.

Card Bundle Administration

MAs control card bundle functionality is in the platform at two levels of detail. The highest level of detail is activating or suspending all platform functionality with regards to a card bundle. The lower level of detail is activating or suspending individual promotions associated with each card bundle.

Product Base Functionality

The types of operations performed by the platform are controlled by the product, bundle group, and card bundle properties, which are configured by administrators.

Loyalty Base Functionality

The platform loads data into the system-based service POS and XML formatted transaction message responses. The base functionality for a transaction request message may be extended by promotions created by MAs. Supported base functions are listed below in Table 1.

TABLE 1
Supported Base Functions, Loyalty Base Functionality

| Transaction Request | Default Functionality |
|---|---|
| Activation | Flags loyalty account as activated, optionally register cardholder |
| | profile information supplied in transaction message fields. |
| Balance Inquiry | Returns loyalty purse balances, purse aliases, and discounts |
| | based on rules for message format. |
| Discount Inquiry | Allow the POS or device to check the platform for discounts. |
| | Discount may be returned as a percentage or amount of purchase. |
| Participation | Promotion rules are typically based on Participation |
| | transactions. A Promotional rule may be created that |
| | automatically activates and/or registers a loyalty account. |
| Participation Cancel | Revokes previously credited points from the cardholder's |
| | account based on promotions and transaction information. |
| Deactivation | Typically initiated by a cardholder concerned about a |
| | lost/stolen/damaged card. |
| Reissue | The transaction performs three actions. The current account |
| | is deactivated, the new account is activated and all of the |
| | cardholder information and current account related |
| | information is transferred to the new account. This |
| | transaction is used for lost, damaged, and stolen cards. If a |
| | cardholder has more than one account and wants to |
| | consolidate, the accounts then use the transfer and deactivate |
| | transactions. |
| Transfer | Allows a cardholder to transfer points from his/her loyalty purse |
| | to another cardholder's loyalty purse. Both loyalty purses must |
| | belong to the same Merchant or Open Coalition Merchant Account. |
| Registration | Cardholder may register for Account, modify information in |
| | previously submitted registration information or delete certain |
| | pieces of information from a previously submitted registration. |
| Reversal | Reverses an action that may have been taken for a previous |
| | Participation or loyalty transaction. This transaction does not |
| | apply to file action, reconciliation, or network management |
| | transactions. |
| Void | A void transaction reverses the effect of a previously approved |
| | loyalty transaction, as requested by a clerk or a merchant |
| | administrator. The void request is required to match a previous |
| | transaction. |
| Renewal | Extends the expiration date of the account for expired and |
| | non-expired accounts |
| Redemption | Allows cardholders to redeem loyalty value. |
| Batch Close | (not supported) |
| Batch Summary | (not supported) |
| Batch Detail | (not supported) |

Stored Value Card Base Functionality

The platform loads data into the system-based service POS 8583 and XML formatted transaction message responses. The base functionality for a transaction request message may be extended by promotions created by MAs. Supported base functions are listed below in Table 2 by message class.

TABLE 2
Supported Base Functions, Stored Value Card

| Transaction Request | |
|---|---|
| Message Class | Default Functionality |
| Activation | Prepares a new card for use, by creating a record of the |
| | account on the SVC system and initializing the |
| | cardholder account balance |
| Authorization | This request concerns obtaining approval for account |
| | funds before taking action. |
| Balance Inquiry | A balance inquiry provides the current defined balance(s) of |
| | the cardholder account. The cash and credit balances are |
| | returned. The open-to-buy balance is not returned. |
| Cash-out | This transaction type is used when the cardholder is not |
| | making a purchase and requests to receive the remaining |
| | balance on the card account in cash. |
| Deactivation | This transaction disables access to the card account. |
| Discount Inquiry | Allow the POS or device to check the platform for |
| | discounts. Discount may be returned as a percentage or |
| | amount of purchase. |
| Force draft capture | It can be used either when completing a previous |
| | authorization or when completing a voice authorization. |
| Last Transaction Inquiry | A last transaction inquiry provides a cardholder with the |
| | date, time, type, location, and amount of the last |
| | transaction as well as the current defined cash and credit |
| | balances of the cardholder account. The open-to-buy |
| | balance is not returned. |
| Pin Change | This transaction changes PIN for the card account. |
| Sale | This transaction type is used when the cardholder is |
| | making a purchase and is not requesting cash from the |
| | card. The sale may be approved for an amount that is less |
| | than or greater than the requested amount. |
| Sale with Cash back/cash- | This transaction type is used when the cardholder is |
| out | making a purchase and requests to receive cash also. The |
| | sale may be approved for an amount that is less than, |
| | equal to, or greater than the requested amount. |
| Reissue | The transaction performs three actions. The current |
| | account is deactivated, the new account is activated and |
| | all of the cardholder information and current account |
| | related information is transferred to the new account. This |
| | transaction is used for lost, damaged, and stolen cards. If |
| | a cardholder has more than one account and wants to |
| | consolidate, the accounts then use the transfer and |
| | deactivate transactions. |
| Renewal | The message extends the expiration date of the account |
| | for expired and non-expired accounts. The transaction is |
| | not used to re-activate a de-activated account. |
| Registration | Cardholder information with the card account. The card |
| | needs to be activated before this transaction can occur. |
| Replenish | A cardholder can increase the balance in the cash account |
| | by replenishing the card with funds accepted by the |
| | merchant; the amount cannot be applied to a credit |
| | account. |
| Return and Merchandise | Applies previously debited funds back to the cardholder's |
| Return | account. |
| Reversal | Reverses an action that may have been taken for a |
| | previous authorization or financial transaction. This |
| | transaction does not apply to file action, reconciliation, or |
| | network management transactions. |
| Void | A void transaction reverses the effect of a previously |
| | approved financial transaction, as requested by a clerk or |
| | a merchant administrator. The void is required to match a |
| | previous transaction. |

Market Administration

Product Purses

Product programs award points to a special type of account called a product purse. The platform automatically creates a default product purse for each card belonging to merchant/coalition. However, MAs can create an additional purse for products belonging to a merchant/coalition and refer to it in the appropriate constraint parameter of a target or behavior template. This enables MAs to link specific promotions to specific purses. The MA must create additional purses before using it in a promotion/program.

Outgoing Messages

Behavior templates may pertain to text messages sent by the platform to the device that originated a transaction: a point-of-sale/terminal display, a receipt/coupon printer, or other device. Messages may inform any number of devices. MAs include custom outgoing messages in rules and promotions. Custom messages and greetings must conform to the system message format.

Promotion/Program Administration

After setting up the trigger and behavior aspects of a promotion, the MA can label and save the program for future retrieval and use by other members of his group. Promotions may also be loaded into the marketing toolkit to be modified and saved under the original label or saving under a different label. MAs activate and suspend promotions from the marketing toolkit interface. An active promotion may not be loaded into the marketing toolkit for modification and saving. MAs may modify only new or suspended promotions.

Templates List

The marketing toolkit provides the following target and behavior templates for MAs to use in constructing promotions (see Table 3).

TABLE 3
Target Templates

| Template | |
|---|---|
| Name | Constraints and Comments |
| Accumulation/ | Balance Type <Constraint> (Current Earned Points, Life |
| Threshold | Time Points Earned and Total points redeemed) |
| | Threshold <Constraint> (e.g. If life time points reaches |
| | 1000, add 10 points to purse) |
| | Type of Frequency <Constraint> |
| | One Time - Occurs once and frequency cursor |
| | doesn't gets reset to initial value |
| | Timed - Cursor gets reset once threshold value |
| | is reached. This type will take another |
| | constrained as time period. |
| | Every Time - Triggered, every time purchase quantity |
| | equals count |
| | Time Period <Constraint> |
| | Purse <Constraint> |
| Business Code | Business Code <Constraint> |
| Date/Time | This could be a day or time interval. (E.g. every second |
| (Temporal) | Friday or 5 P.M to 7 P.M every day.) |
| First Time | Purse Scope <Constraint> (Global or Purse) |
| Activation | If Purse then Purse must be define. |
| Grouping | Type <Constraint> (Product/Bundle Group/Bundle) |
| | Id <Constraint> (Product Id/Bundle Group Id/Bundle Id) |
| Pre/Post- | Transaction Type <Constraint> (i.e. Pre or Post |
| Authorization | Authorization, Sale) |
| and | |
| Participation/ | |
| Sale | |
| Random | Total plays <Constraint> Number of tries that are |
| Number | allowed until the promotion ends. (I.e. your chances are |
| (Instant Win) | (1/tries left * prices left) |
| | Price Count <Constraint> Number of prices to give away |
| | Promotion ID <Constraint> Allows multiple rules to be |
| | combined into a single promo with the same rules but |
| | different prices |
| | Number Of Wins <Constraint> Max allowed wins for a |
| | member/card |
| | Period <Constraint> Period for which the No of Wins |
| | applies |
| Scope | Scope Type <Constraint> (Merchant, Brand, Division, |
| | Region or Store) |
| | Scope ID <Constraint> (A specific Merchant, Brand, |
| | Division, Region or Store) |
| Total Amount | Transaction Type <Constraint> |
| of Transaction | Amount <Constraint> |
| Transaction | Transaction Type (i.e. Reversal, Registration, Funding, |
| Equality | Redemption) |
| Transaction | Type of Frequency <Constraint> |
| Frequency | One Time - Happens once and cursor doesn't |
| | gets reset to initial value |
| | Timed - Cursor gets reset once threshold value |
| | is reached. This type will take another |
| | constrained as time period. |
| | Every Time - Triggered, every time purchase quantity |
| | equals count |
| | Count <Constraint> (Number of items.) |
| Product Code | Product Code <Constraint> |
| Amount | Dollar Amount <Constraint> |
| Product Code | Product Code <Constraint> |
| Equality | |
| Product Code | Product Code <Constraint> |
| Frequency | Type of Frequency <Constraint> |
| | One Time - Occurs once and cursor doesn't |
| | gets reset to initial value |
| | Timed - Cursor gets reset once threshold value |
| | is reached. This type will take another |
| | constrained as time period. |
| | Every Time - Triggered every time purchase quantity |
| | equals count |
| | Time Period <Constraint> |
| | Count <Constraint> (Number of items.) |
| Product Code | Product Code <Constraint> |
| Quantity | Range <Constraint> (Quantity between x and y) |

Behavior templates are shown in Table 4.

TABLE 4
Behavior Templates

| Usage | Constraints |
|---|---|
| Add Value To | Purse <Constraint> |
| Purse | Value <Constraint> |
| | Closed Coalition Id/Client Id <Constraint> (optional) |
| Coupon/ | Product code <Constraint> (Optional: If coupon is for |
| Discount | any specific product code) |
| | Discount <Constraint> (Discount earned for the current |
| | transaction) |
| | Real-Time <Constraint> (Coupon or Real-Time) |
| | Closed Coalition Id/Client Id <Constraint> (optional) |
| | Purse <Constraint> |
| | Expiration Date <Constraint> |
| Message | Message <Constraint> (Greeting, Custom) Pre defined |
| Queue Point | variables would be used to construct custom messages |
| Totals | i.e. First Name, Last Name |
| Notification | Subject <Constraint> |
| | Message Body <Constraint> |
| | Recipient's Information <Constraint> (Optional: defaults |
| | to email.) |
| Use Purse For | Purse <Constraint> |
| Transaction | Transaction <Constraint> Transaction Type (Auth, Sale, |
| | DC, Redemption) |
| | Priority <Constraint> (Number defining priority of usage |
| | in transaction) |

User Interfaces

User Interfaces Introduction

User interfaces to the platform are implemented as Web-based GUIs communicating over the Internet via HTTPS protocol.

The following browsers are supported by the platform:

Internet Explorer versions 4.x and higher

Netscape Communicator versions 4.x and higher

User authentication is based on the login/password information submitted by users logging into the system. IP range checking and other network security checks are handled by the firewall configured by the system Platform administrators.

System Administration Panel

The system superuser (SSU) performs operations affecting the platform as a whole by entering configuration information and viewing reports from the system administration panel (see Table 5).

TABLE 5
System Administration Panel, Functions

| Function | Preconditions |
|---|---|
| Create/Update Merchant/Open Coalition | SSU has loaded the required data into the |
| Account. The SSU points the Account | database: Merchant Name, list of Alliance |
| Creation control to the preloaded Merchant | POS 8583 Store IDs, (Optional) Alliance |
| Account data. | POS 8583 Business code for merchant. Or |
| | loaded data into a user interface. |
| Create MSU User Profiles for a Merchant | Merchant Account has been created |
| Account by entering required profile | previously. |
| information for each login and initial | |
| password. | |
| Assign MSU Profiles to the MSU Group for | MSU User profiles have been created |
| a Merchant Account | previously. |
| Activate/Suspend all Platform Operations | Merchant Account has been created |
| associated with a Merchant Account or | previously |
| Open Coalition Account | |
| Open Coalition Account | |
| Add Merchant Accounts to Open Coalition | Open Coalition Account has been created |
| Merchant Accounts | previously and a new merchant needs to be |
| | added. |
| Add/Remove Merchant Account data | Closed Coalition Account has been created |
| references from Closed Coalition Merchant | previously. Merchant Accounts supplying |
| Accounts. | data references have been created |
| | previously. |
| Search System and Platform Error logs by | None |
| transaction date range, transaction type, | |
| Merchant Account, Cardholder/Card | |
| Account, User login or name, other System- | |
| specific information contained in logs, | |
| searchable by any combination of the above. | |

Reports

System and error logs, sorted and grouped by any data types present in a report.

Merchant Superuser Control Panel

The merchant superuser (MSU) performs operations affecting the merchant account as a whole by entering configuration information and viewing reports from the control panel.

Functions

Configure the system to implementation specifics of the merchant's point-of-sale (see Table 6).

TABLE 6
Merchant Superuser Control Panel, Functions

| Function | Preconditions |
|---|---|
| Update personal profile information if | MSU can log in as a member of an MSU |
| necessary. Includes changing password. | Group with Merchant level permissions. |
| Configure the system to implementation | Merchant Account has been created and |
| specifics of the merchant's Point-of-Sale | activated by SSU. |
| devices. The following information is | activated by SSU. |
| required: Point-of-Sale or Zowi Platform | |
| will supply the Alliance POS 8583 | |
| formatted Batch ID for each transaction | |
| Enter settings for all configuration | Merchant Account has been created and |
| parameters listed in Table 5-1 of the | activated by SSU. |
| Alliance POS 8583 Stored Value Card | |
| Supplement Implementation Guide | |
| Enter Region labels for grouping stores | Merchant Account has been created and |
| | activated by SSU. |
| Assign stores to Regions | Region labels have been created previously. |
| Enter Profile information for MAs to create | Merchant Account has been created and |
| MA Users (Name, email address, login, | activated by SSU. |
| initial password) | |
| Create new types of Groups from Predefined | Merchant Account has been created and |
| Groups by adding/removing Operations | activated by SSU. |
| from Group permissions and setting Scope | |
| access level | |
| Assign Users to Groups | Groups and User Profiles have been created |
| | previously. |
| Remove Users from Groups | Groups and User Profiles have been created |
| | previously. |

Marketing Toolkit

The merchant administrator (MA) performs operations affecting card bundles by entering configuration information and viewing reports from the marketing toolkit. MSUs may also administrate individual card bundles from the marketing toolkit.

Functions

All of the functions listed in Table 7 below are restricted by scope and operations permissions set for the MA group member accessing the marketing toolkit.

TABLE 7
Marketing Toolkit, Functions
Function

Configure a card bundle: create label
Configure a card bundle: enter card quantity
Configure Client Product: Add product purse
Configure Client Product: Set card type
Define properties: Set product properties
Examples of properties:
One Time Use (Gift Card/Certificate) or Multi-Use Gift Card
Expiration Date Rules
Set activation or re-activation fee amount
Max Funding Limit
Set store restriction (If only good at one store)
Create Promotions: select a Preset Promotion, select card bundle, bundle
group or product and fill out required Constraints
Create Modify Preset: customize a Preset Promotion by swapping
Templates. Only fully configured Promotions can be activated.
Create Preset: define a Trigger by combining any number of Target
Templates and filling out the Constraint parameters. Then define a
Behavior by combining any number of Behavior Templates and filling out
Constraint parameters
Activate Promotions: select a previously saved Promotion and set it to
“active”
Suspend Promotions: select an active Promotion and set it to “suspended”
View Promotions: A tool that allows the MA to browse the promotions.
View Reports: MA view reports available based on their permissions.
Configure a Bundle Group: create label
View Card Bundles and Bundle Groups
Recall Card Bundle or Card
Customize Coalition/Merchant website: Set up or modify deals and
discounts.
Customize Coalition/Merchant website: Set up or modify banners.
Customize Coalition/Merchant website: Set up or modify required fields
for registration.
Customize Coalition/Merchant website: Modify household links
Adding value to the product purse based on product, bundle group, bundle
and all.
Set conversion from loyalty to cash and vice-versa
Email advertising to registered members based on product, bundle group,
bundle and all

Reports

The platform has a separate data warehouse for reporting. This allows for real time reporting without diminishing system performance. The data ware house has a mirroring capability to maintain synchronization with the production data base.

The list of reports includes:

Summary Reports

Account Summary

Bundle Group Summary

Recall Summary

Scope Transaction Summary

Terminal Summary

Transaction Summary

Detail Reports

Account Detail

Bundle Detail

Scope Transaction Detail

Terminal Detail

Total Transaction Detail

Account Balances

Expired Accounts By Scope

Registered Accounts

Expired Accounts

Value Transfers

Trend Reports

Report summarizing loyalty program sales and membership

Report containing members with no loyalty transactions since a specified date, date of last transaction

Specific Product Code Net Product sales for a date range

Customer Support Panel

The customer support representative (CSR) performs operations affecting card bundles and customers by entering configuration information and viewing account and transaction data from the customer service panel. Typically, CSR has merchant/coalition level scope access to resolve issues for cardholders. Merchant/coalition name appears on all pages that relate to specific cardholder accounts.

Functions

All of the functions listed in Table 8 below are restricted by scope and operations permissions set for the CSR group member accessing the customer service panel.

TABLE 8
Customer Support Panel, Functions
Function

Search for cardholders in the database
View cardholder profile and account information
Modify cardholder profile settings and account values according to
permissions set by MSU administrators
Suspend cardholder accounts
Perform Point-of-Sale/Terminal Operations on behalf of a Point-of-Sale
Operator in case the store's network connection to the Acquirer's
host is down
Retrieve a card number from the database to order a replacement
Submit reports of anomalous system behaviors
Retrieve information on a specific transaction
User Action audit trail (action tracking)
Store Directory Search
Submit Transaction: (Transactions must be associated with a store id and
CSR must provide transaction details.)
Activation
Authorization
Balance Inquiry
Deactivation
Force draft capture
Last Transaction Inquiry
Participation
Participation Cancel
Pin Change
Registration
Re-Issue
Replenish
Return and Merchandise Return
Sale
Transfer
Void
Task Reminder: Reminds the CSR of Follow up tasks
Task Reminder Set: Allows the CSR to setup a task reminder
CSR Create, Modify, View, Search, Close and Re-Open Call Ticket/Bug
View/Add/Remove funding source for web
Renewal

Presentation Interface

The platform provides a set of operations and reports designed to give cardholders direct control over certain aspects of their loyalty and stored value card accounts. MAs can grant permission for cardholders to use those operations and reports deemed appropriate for a particular bundle group or product. MAs can allow cardholders to view their account balances, update their profile information, replenish their stored value cards, and more.

Functions

All of the functions listed in Table 9 below may or may not be available to cardholders, depending on the MA-specified card bundle settings.

TABLE 9
Presentation Interface, Functions

| Function | Data Fields | Preconditions and Comments |
|---|---|---|
| Register for an | Name | Cardholder may or may |
| Account | Address/Phone | not have a card. |
| | Email | |
| | DOB | |
| | Login | |
| | Password | |
| | PIN | |
| | Social Security Number | |
| | (Optional, but | |
| | recommended.) | |
| Add Members | Name | Additional Members may or |
| | Address/Phone | may not have a card. |
| | Email | |
| | DOB | |
| | Login | |
| | Password | |
| Suspend Members | Selected by Profile info | Cardholder is primary |
| | and/or Account number | Account owner. |
| Request a Card | Quantity | |
| Request a Card | Account number | Cardholder has active card |
| Replacement | | Account. |
| Load (Activate)/Replenish | Account number | For security reasons, |
| Stored Value | Load Amount (if card is | merchants may require that the |
| | non-denominated) | cardholder have ‘dead’ card in |
| | Payment info: may | hand prior to activation and |
| | include credit/debit card | initial loading. |
| | info, bank info, SSN. | |
| Modify Profile Info | Name | Cardholder has a User Profile. |
| | Address/Phone | |
| | Email | |
| | DOB | |
| | Login | |
| | Password | |
| View Balances | All Product Balances | |
| View Statements, Transaction | Dates, Product Codes, | |
| Summary and pending/ | Store names and | |
| declined transactions | addresses, purchase totals, | |
| | item totals | |
| Set up Household Links | Card Numbers | |
| | Pin(s) (Optional) | |
| Add/Remove Funding Source | Check: | |
| | MICR (Magnetic Ink | |
| | Character Recognition) | |
| | Number: Routing and | |
| | Account | |
| | Name and Address | |
| | Social Security Number | |
| | Driver License Number | |
| | Credit/Debit: | |
| | Card Number | |
| | Expiration Date | |
| | Name and Billing | |
| | Address | |
| | CVV (Card Verification | |
| | Value) | |
| View Deals and Discounts | | (This is optional) |
| Auto replenishment | Funding source | |
| | Amount | |
| | Frequency | |

System-based service System Integration (Loyalty)

Table 10 below lists distinct loyalty-based and SVC transactions.

TABLE 10
Loyalty-based and SVC Transactions

| Name | Product | Exceptions/Exception Rules | Fee |
|---|---|---|---|
| Activation | All | | Yes |
| Balance Inquiry | All | This fee only applies when Balance | Yes |
| | | Inquiry occurs without another | |
| | | transaction. | |
| Batch Deposit | All | 60 Days free Merchant/Coalition | Yes |
| | | account creation date. After each | |
| | | conversion, the merchant may make | |
| | | a batch deposit to the converted | |
| | | accounts without a fee. | |
| Batch | All | | No |
| Registration and | | | |
| Conversion | | | |
| Deactivation | All | | No |
| Device | All | | No |
| Authentication | | | |
| Discount Inquiry | All | | No |
| Modify | All | | Yes |
| Registration | | | |
| Pin Change | All | | Yes |
| Ping | All | | No |
| Registration | All | 60 Days free from Merchant/ | Yes |
| | | Coalition account creation date. | |
| Reissue | All | | Yes |
| (Lost/Stolen) | | | |
| Renewal | All | | Yes |
| Reversal | All | | No |
| Statements | All | Defined as, All information pulled | Yes |
| | | for a date range for a single account | |
| | | or a set of household accounts is | |
| | | considered a single statement | |
| Transfer | All | | Yes |
| Void | All | | No |
| Create Account | Loyalty | | Yes |
| Links | | | |
| Participation | Loyalty | Behaviors determine transactions. | No |
| Participation | Loyalty | | No |
| Cancel | | | |
| Redemption | Loyalty | Behaviors determine transactions. | No |
| Last Transaction | SVC | | Yes |
| Inquiry | | | |
| Replenish | SVC | | Yes |
| Return | SVC | | No |
| Sale/Pre-Post | SVC | | Yes |
| Withdraw/ | SVC | | Yes |
| CashOut | | | |

Table 11 below lists template/toolkit driven transactions.

TABLE 11
Template/Toolkit Driven Transactions

| Name | Description | Exceptions | Fee |
|---|---|---|---|
| Accumulation/ | Allows points to be issued | | No |
| Threshold | either based on balance or | | |
| | amount of points earned. | | |
| Business Code | The template defines the | | No |
| | Business Codes that maybe | | |
| | sent by the Point-of-Sale or | | |
| | other device to be used in | | |
| | rules. | | |
| Card ID template | Cardholders, such as VIP's, | | No |
| | may be assigned to groups | | |
| | that enjoy special discounts | | |
| | and other benefits in | | |
| | response to targeted | | |
| | behaviors | | |
| Card Status | First-time users of loyalty | | No |
| Template | and/or stored value cards | | |
| | may receive additional | | |
| | benefits, such as loyalty | | |
| | point awards | | |
| Custom | Using simple text tags | | Yes |
| Messaging | custom messages can be | | |
| (Product) | define for printing on the | | |
| | receipt. If combined with a | | |
| | Product Code action | | |
| | template it can issue a | | |
| | product message. | | |
| Date/Time | Targeted behaviors are | | No |
| (Temporal) | performed when | | |
| | transactions are within a | | |
| | defines a span of dates | | |
| Decline | Causes a transaction to be | | No |
| Transaction | declined when the rule | | |
| | executes. | | |
| Discount/Coupons | Discount coupons may be | | Yes |
| template | issued either at the Point-of- | | |
| | Sale device and printed | | |
| | coupons for later use or | | |
| | against the current | | |
| | transaction (in real-time). | | |
| | This template can also be | | |
| | used to issue prizes or | | |
| | sweepstakes awards. | | |
| Frequency | Allows the program/rule to | | No |
| | execute at specific intervals. | | |
| Grouping | Scope may be defined in the | | No |
| | program by product, bundle | | |
| | group and card bundle. | | |
| | This template is mandatory, | | |
| | because the rule must have | | |
| | product(s) or subsystems to | | |
| | effect. | | |
| Instant Win | MA's can define the type of | | No |
| (Sweepstakes) | rewards and the number of | | |
| selection template | each type. These rewards | | |
| | will be given randomly to | | |
| | users that meet the other | | |
| | action template | | |
| | requirements. | | |
| Loyalty Point | Merchant may set a cash | | No |
| Conversion | conversion amount for | | |
| Template | redemptions that involve | | |
| | translating points to cash. | | |
| Messaging | MA may customize the | | No |
| templates: | greeting to the user using a | | |
| Greeting | format similar to the | | |
| | Custom Messaging | | |
| | Template. | | |
| Messaging | MA may select any | | No |
| templates: Point | combination of Lifetime | | |
| Messaging | Point Total, Current Point | | |
| | Total and Sale Point Total | | |
| Notification | Defines email notifications | | No |
| | that maybe sent based on | | |
| | action templates. | | |
| | Notifications use the same | | |
| | tags as the custom message | | |
| | template for customization. | | |
| | Notifications may be used | | |
| | for internal notifications or | | |
| | to notify the cardholder via | | |
| | email | | |
| Pre/Post- | Allows program to behave | | No |
| Authorization and | differently based upon | | |
| Participation/Sale | authorization types. | | |
| Product Code | Allows groups of product | | No |
| Grouping | codes to be loaded into the | | |
| Template | system and used in | | |
| | promotions as a group. | | |
| Product code | Defines the amount of | | No |
| template: Amount | purchase exceeds or meets | | |
| | the defined amount. | | |
| Product code | Product code template | | No |
| template: Equality | where the product code | | |
| | defined in the template | | |
| | matches those defined in the | | |
| | transaction | | |
| Product code | Template defines a | | No |
| template: | particular product and the | | |
| Frequency | specific number of times | | |
| | purchased within defined | | |
| | span of dates | | |
| Product code | Defines the product code | | No |
| template: Quantity | and the quantity | | |
| Redemption | Cardholder redeems loyalty | | Yes |
| | value. | | |
| Reward to purse | Cardholder earns value or | If participation is split into | Yes |
| template | Allows the MA to issue | pre-auth and post-auth there | |
| | rewards of points, products | is only one fee participation. | |
| | and/or cash for any action | | |
| | or set of actions to a | | |
| | specific purse. | | |
| Reward to purse | This template allows the | If participation is split into | Yes |
| template: Points | MA to issue points based on | pre-auth and post-auth there | |
| for gas quantity | the amount of gas | is only one fee participation. | |
| template | purchased. | | |
| Reward to purse | This template allows the | If participation is split into | Yes |
| template: Points | MA to issue points based on | pre-auth and post-auth there | |
| for Spending | amounts spent. | is only one fee participation. | |
| template | | | |
| Scope ID template | Purchase from within a | | No |
| | defined scope (i.e. a | | |
| | particular store, region, | | |
| | division, brand, client or | | |
| | coalition). | | |
| Select Rule Target | This is a required template | | No |
| Template | that allows the MA to select | | |
| | Product, Bundle Group or | | |
| | Bundle for which the rule | | |
| | applies. | | |
| Transaction | Defines transaction types to | | No |
| Template | execute behavior template | | |
| | upon transaction type | | |
| Transaction | Causes the system to | | No |
| Templates: | execute behaviors when | | |
| Amount | amount of purchase exceeds | | |
| | or meets the defined | | |
| | amount. | | |
| Transaction | Defines transaction types to | | No |
| Templates: | execute behavior template | | |
| Equality | upon transaction type | | |
| Transaction | Targeted behaviors are | | No |
| Templates: | performed if the consumer | | |
| Frequency | makes specific type of | | |
| | transaction a defined | | |
| | number of times within | | |
| | defined span of dates | | |
| Use Purse For | MA may select which purse | | No |
| Transaction | to use for a rule/promotion. | | |

Although the invention is described herein with reference to the preferred embodiment, one skilled in the art will readily appreciate that other applications may be substituted for those set forth herein without departing from the spirit and scope of the present invention. Accordingly, the invention should only be limited by the claims included below.

1. A stored value apparatus for operation in connection with a plurality of point-of-sale devices, wherein at least one of said point-of-sales devices is not collocated with others of said point-of-sale devices, and wherein at least one of said point-of-sale devices exchanges information via a network using a native format and/or protocol that is different from a native format and/or protocol of others of said point-of-sale devices, said apparatus comprising:
a stored value platform;
a network for exchanging information between said point-of-sale terminals and said stored value platform;
a translator associated with said stored value platform for receiving information from said point-of-sales terminals via said network in any and all of said point-of-sale terminal native formats and/or protocols and for converting said information to a stored value platform format/protocol; said translator receiving information from said stored value platform in said stored value platform format/protocol and converting said information to a point-of-sale terminal native format and/or protocol for an intended destination point-of-sale terminal; and
at least one stored value application associated with said stored value platform for exchanging said information with said point-of-sale terminals in a stored value platform format/protocol via said translator; said stored value application effecting a stored value function in real time with any of said point-of-sales terminals.

2. The apparatus of claim 1, wherein said stored value function is any of a loyalty card, cash card, and gift card function.

3. The apparatus of claim 1, wherein each point-of-sale terminal comprises a specific transaction format; and wherein said stored value platform further comprises means for identifying each point-of-sale terminal based upon said point-of-sale terminal transaction format.

4. The apparatus of claim 1, wherein each point-of-sale terminal native format and/or protocol further comprises a specific transaction format; and wherein said stored value platform further comprises a template for identifying a transaction source associated with said transaction format.

5. The apparatus of claim 1, wherein said translator is modular and extensible to accommodate both the addition of, and deletion of point-of-sale terminal native formats and/or protocols.

6. A stored value platform, comprising:
an access engine for receiving requests for pre/post transaction authorization and sale messages for supported products from a transaction device in connection with a transaction performed at said transaction device;
a universal translator for translating a transaction device-based messaging protocol into a platform format; and
a data processing and storage facility for providing loyalty reward and payment product processing in response to any of said transaction device requests and messages; for generating a response message; and for sending said response message in said platform format to said universal translator;
wherein said universal translator translates said response message into said transaction device-based messaging protocol; and
wherein said access engine sends said response message in said transaction device-based messaging protocol to said transaction device that initiated said transaction.

7. The platform of claim 6, said universal translator comprising:
a plurality of plug-in modules that are capable of translating incoming messages in any of a plurality of data formats to said platform format.

8. The platform of claim 7, wherein said plug-in modules support proprietary and open protocols.

9. The platform of claim 7, wherein new data formats can be added without making changes to said platform.

10. The platform of claim 6, further comprising:
a system API for integrating said platform into merchant internal systems without requiring custom development.

11. The platform of claim 10, wherein a merchant can associate customer behavior on said merchant's Web site with a corresponding behavior on said platform.

12. The platform of claim 6, further comprising:
an interface for real-time interaction between said platform and merchants' proprietary system.

13. A stored value method, comprising the steps of:
providing a stored value platform; and
providing a translator associated with said stored value platform for allowing input devices, associated with outside systems and networks, used by merchants to issue points, register accounts, and perform other administrative tasks from any of PC, Web-based, and closed-system input devices, said translator ensuring consistency of data sent to said platform and responses sent from said platform to said input devices.

14. The method of claim 13, wherein said data comprises:
a file listing a series of transactions which is sent to said platform from merchants or merchant vendors.

15. The method of claim 13, further comprising the step of:
providing an interface for real-time interaction between said platform and a merchants' proprietary system.

16. The method of claim 15, further comprising the step of:
sending transaction messages arriving at said real-time interface to a security manager to determine eligibility for further processing.

17. The method of claim 16, said security manager implementing one or more permissions, which comprise a combination of operation and scope; wherein users are only permitted to view reports and access system controls as designated by permissions and scope; wherein users with permissions at one scope may perform operations based on permissions within or below their assigned scope; and wherein users may not perform operations above their assigned scope.

18. The method of claim 17, further comprising the step of:
said security manager assigning a set of permissions to a group, wherein each user must be and is only a member of one group.

19. The method of claim 17, further comprising the step of:
said security manager authenticating a transaction, verifying message format, and granting access to operations based on said permissions.

20. A stored value platform, comprising:
a stored value application associated with said platform;
a presentation interface for providing Web-based access for both merchant and cardholder interaction with said stored value application; and
a universal translator for converting different incoming data from said merchant to a standard platform format for use by said stored value application.

21. A stored value framework, comprising:
a real-time messaging system;
a stored value application for receiving messages from a merchant or merchant partner via said real-time messaging system, wherein said merchant or merchant partner deposits cash or issues points and/or rewards pursuant to cardholder transactions; and
a universal translator for converting different incoming data from said merchants or merchant partners to a standard platform format for use by said stored value application.

22. A stored value method for operation in connection with a plurality of point-of-sale devices, wherein at least one of said point-of-sales devices is not collocated with others of said point-of-sale devices, and wherein at least one of said point-of-sale devices exchanges information via a network using a native format and/or protocol that is different from a native format and/or protocol of others of said point-of-sale devices, said method comprising the steps of:
providing a stored value platform;
exchanging information between said point-of-sale terminals and said stored value platform;
receiving information from said point-of-sales terminals in any and all of said point-of-sale terminal native formats and/or protocols;
converting said information to a stored value platform format/protocol;
receiving information from said stored value platform in said stored value platform format/protocol;
converting said information to a point-of-sale terminal native format and/or protocol for an intended destination point-of-sale terminal; and
effecting a stored value function in real time with any of said point-of-sales terminals.

23. The method of claim 22, wherein said stored value function is any of a loyalty card, cash card, and gift card function.

24. The method of claim 22, wherein each point-of-sale terminal comprises a specific transaction format; and wherein said stored value platform further comprises the step of:
identifying each point-of-sale terminal based upon said point-of-sale terminal transaction format.

25. The method of claim 22, wherein each point-of-sale terminal native format and/or protocol further comprises a specific transaction format; and wherein said stored value platform further comprises the step of:
providing a template for identifying a transaction source associated with said transaction format.

26. The method of claim 22, wherein said translator is modular and extensible to accommodate both the addition of, and deletion of point-of-sale terminal native formats and/or protocols.

27. A stored value method, comprising the steps of:
receiving requests for pre/post transaction authorization and sale messages for supported products from a transaction device in connection with a transaction performed at said transaction device;
translating a transaction device-based messaging protocol into a platform format;
providing loyalty reward and payment product processing in response to any of said transaction device requests and messages;
generating a response message;
translating said response message into said transaction device-based messaging protocol; and
sending said response message in said transaction device-based messaging protocol to said transaction device that initiated said transaction.

28. The method of claim 27, further comprising the step of:
providing a plurality of plug-in modules that are capable of translating incoming messages in any of a plurality of data formats to said platform format.

29. The method of claim 28, wherein said plug-in modules support proprietary and open protocols.

30. The method of claim 28, wherein new data formats can be added without making changes to said platform.

31. The method of claim 27, further comprising the step of:
providing a system API for integrating said platform into merchant internal systems without requiring custom development.

32. The method of claim 31, wherein a merchant can associate customer behavior on said merchant's Web site with a corresponding behavior on said platform.

33. The method of claim 27, further comprising the step of:
providing an interface for real-time interaction between said platform and a merchants' proprietary system.

34. A stored value apparatus, comprising:
a stored value platform; and
a translator associated with said stored value platform for allowing input devices, associated with outside systems and networks, used by merchants to issue points, register accounts, and perform other administrative tasks from any of PC, Web-based, and closed-system input devices, said translator ensuring consistency of data sent to said platform and responses sent from said platform to said input devices.

35. The apparatus of claim 34, wherein said data comprises:
a file listing a series of transactions which is sent to said platform from merchants or merchant vendors.

36. The apparatus of claim 34, further comprising:
an interface for real-time interaction between said platform and a merchants' proprietary system.

37. The method of claim 36, further comprising:
means for sending transaction messages arriving at said real-time interface to a security manager to determine eligibility for further processing.

38. The apparatus of claim 37, said security manager implementing one or more permissions, which comprise a combination of operation and scope; wherein users are only permitted to view reports and access system controls as designated by permissions and scope; wherein users with permissions at one scope may perform operations based on permissions within or below their assigned scope; and wherein users may not perform operations above their assigned scope.

39. The apparatus of claim 38, further comprising:
means for said security manager assigning a set of permissions to a group, wherein each user must be and is only a member of one group.

40. The apparatus of claim 38, further comprising:
means for said security manager authenticating a transaction, verifying message format, and granting access to operations based on said permissions.

41. A stored value method, comprising the steps of:
providing a stored value application associated with a stored value platform;
providing Web-based access for both merchant and cardholder interaction with said stored value application; and
converting different incoming data from said merchant to a standard platform format for use by said stored value application.

42. A stored value method, comprising the steps of:
providing a real-time messaging system;
receiving messages from a merchant or merchant partner via said real-time messaging system;
said merchant or merchant partner depositing cash or issuing points and/or rewards pursuant to cardholder transactions; and
converting different incoming data from said merchants or merchant partners to a standard platform format for use by said stored value application.
